(19) United States
(12) Patent Application Publication
(10) Pub. No.: US 2013/0045877 A1
(43) Pub. Date: Feb. 21, 2013

(54) METHODS TO FORM SUBSTRATES FOR OPTICAL SENSING BY SURFACE ENHANCED RAMAN SPECTROSCOPY (SERS) AND SUBSTRATES FORMED BY THE METHODS

(71) Applicants: Fung Ling Yap, Singapore (SG); Sivashankar Krishnamoorthy, (US); Praveen Thoniyot, (US); Vignesh Suresh, (US); Sanghamitra Dinda, (US)

(72) Inventors: Fung Ling Yap, Singapore (SG); Sivashankar Krishnamoorthy, (US); Praveen Thoniyot, (US); Vignesh Suresh, (US); Sanghamitra Dinda, (US)

(73) Assignee: Agency for Science, Technology and Research, Connexis (SG)

(21) Appl. No.: 13/588,635

(22) Filed: Aug. 17, 2012

(30) Foreign Application Priority Data
Aug. 19, 2011 (SG) 201106015-9

(51) Int. Cl. C40B 30/00; C40B 50/18; C40B 40/14; B82Y 15/00; B82Y 30/00

(52) U.S. Cl. 506/7; 506/32; 506/20; 977/773; 977/810; 977/788; 977/890; 977/902

(57) ABSTRACT

A method of manufacturing a substrate is provided. The method comprises, in some aspects, a) providing a support; b) forming a template by attaching a plurality of polymeric nanoparticles some or all having a core-shell structure to the support, wherein the core comprises a first polymer and the shell comprises a second polymer; and c) forming the metal nanoarray substrate by attaching a plurality of metallic nanoparticles to at least some of the polymeric nanoparticles of the template. A biosensor comprising a substrate manufactured by the method, and a method for the detection of an analyte in a sample by surface enhanced Raman spectroscopy (SERS) is also provided.

### CROSS-REFERENCE TO RELATED APPLICATIONS

This application makes reference to and claims the benefit of priority of an application for “A Method For Fabricating Metal Nanoarrays On Optical Fiber Faucet For High-Performance SERS Based Remote Sensing Of Molecular Analytes, Using Directed Self-Assembly Gold Nanoparticles” filed on Aug. 19, 2011, with the Intellectual Property Office of Singapore, and there duly assigned serial number 201106015-9. The content of said application filed on Aug. 19, 2011, is incorporated herein by reference in its entirety for all purposes.

### TECHNICAL FIELD

Some aspects of the invention relate to methods of forming substrates for optical sensing by surface enhanced Raman spectroscopy (SERS), and to substrates formed by the methods.

### BACKGROUND

Vibrational spectroscopic techniques, such as infra-red (IR), normal Raman Spectroscopy and Surface Enhanced Raman Spectroscopy (SERS), have been considered for analyte detection. Of these, SERS has evolved as one of the more sensitive techniques for analyte detection due to the enhancement of the Raman spectral intensity by interaction of the adsorbed SERS active analyte molecules with the surface of a metal substrate.

A major application for SERS substrates is in its use as a biosensor. With an extremely small cross-sectional Raman scattering area of 10⁻²⁹ cm², Raman scattering signals are innately weak. Contrary to previously held presumptions that laser excitation frequency forms the basis for signal enhancement, the density of Raman hotspots on a substrate surface is presently considered to be an important factor affecting Raman signal intensity. For SERS substrates comprising nanoparticles, for example, a Raman hotspot can exist in a gap or junction between adjacent metal nanoparticles that are in close proximity to one other. These hotspots have been identified using atomic force microscopy (AFM) characterization and SERS studies as chemisorptions site for analyte molecules. Near convergence of two nanoparticles may induce coupling of their individual transition dipoles, which include ballistic carriers in oscillation. Coherent interference of their electromagnetic (EM) field may lead to a red-shift in coupled plasmon resonance, and may result in amplification of the signal intensity. Accordingly, the strength of the Raman signal has been found to be proportional to the number of hotspots. By varying the density of Raman hotspots on a SERS substrate, signal enhancement of up to 14 orders in magnitude has been reported.

Although SERS has established itself as an important analytical technique in recent years, there remains a need for substrate-related improvements for wider adoption of the technique in biological and environmental sensing. Commercialization of SERS techniques has thus far been limited due to a number of challenges.

Firstly, to achieve effective biosensing capability, the inherently large variation of Raman signals has to be ameliorated. As the SERS substrate forms a key component in SERS measurements, various groups have attempted to provide improved SERS substrates. Generally, a good SERS substrate should be capable of producing optimal Raman signal enhancement with reliable reproducibility. However, state-of-the-art SERS substrates often suffer from non-uniform enhancement across their surfaces, as existing substrate fabrication processes aim to enhance signals for single-molecule detection, and as a result, produce hotspot congregations that are highly localized. For practical applications, substrates with high reproducibility are more suitable as they allow consistent generation of SERS results.

Other substrate-related issues include inconsistent signal enhancement at different points on the same substrate, batch-to-batch variations in signal, the complexity of fabrication, cost effectiveness of mass production, the stability of the substrate, and the difficulty of detecting wide range of analytes.

Even though techniques such as electron beam lithography have been used to produce precise and well-defined metallic arrays on substrates to overcome such reproducibility issues, these techniques are expensive and time consuming. Furthermore, these techniques lack the ability to fabricate arrays over macroscopic areas, thereby posing problems in terms of scalability. State-of-the-art techniques are also usually not versatile, in that they are not able to be used on the surfaces of some types of material, and are not able to be used on non-planar surfaces.

In one specific SERS technique, optical fibers have been used for in situ monitoring. This technique has various advantages over conventional substrate-based methods, such as compactness, flexibility and remote sensing capability. Therefore, cost-effective and reliable substrate fabrication techniques that may be extended to optical fibers hold great value in taking SERS-based sensing into practical utility in a number of areas, e.g. the bio-processing industry, real-time monitoring of chemical reactions and in vivo biosensing, and monitoring of toxic chemical/biological warfare agents.

Conventional two-dimensional arrays of gold or silver nanoparticles have been achieved on optical fibers using self-assembly of gold nanoparticles on amine or thiol terminated silane self assembled monolayers (SAMs). However, inconsistencies due to the lack of reproducibility of the self-assembly process, low signal enhancement in SERS, and the possibility of random multilayer formation on the fiber tip, resulting in opaque fiber faucets, are issues compromising the applicability of this technique.

Even though techniques such as UV lithography and nanoimprinting have also been used, these techniques still suffer from limitations relating to signal enhancement, as well as ease of fabrication. To achieve higher signal enhancement, researchers have used an optical fiber with a SERS substrate at the tip in a metal nanoparticle solution to increase the number of hotspots. However, this technique is cumbersome and cannot be translated into biological environment, since nanoparticle solutions cannot survive the harsh ionic conditions of biological media.

In view of the above, there remains a need for an improved substrate for optical sensing using SERS, as well as improved methods for forming the substrate that addresses at least one or more of the above-mentioned problems.

### SUMMARY OF THE INVENTION

In a first aspect, the invention refers to a method of manufacturing a metal nanoarray substrate. The method comprises:
a) providing a support;
b) forming a template by attaching a plurality of polymeric nanoparticles some or all having a core-shell structure to the support, wherein the core comprises a first polymer and the shell comprises a second polymer; and
c) forming the metal nanoarray by attaching a plurality of metallic nanoparticles to at least some of the polymeric nanoparticles of the template.

In a second aspect, the invention refers to a metal nanoarray substrate obtained by an inventive method according to the first aspect.

In a third aspect, the invention refers to a biosensor comprising a metal nanoarray substrate manufactured by an inventive method according to the first aspect.

In a fourth aspect, the invention refers to a method for the detection of an analyte in a sample by SERS, comprising contacting the sample with the biosensor according to the second aspect.

In addition, other aspects of the invention are discussed in more detail below.

### BRIEF DESCRIPTION OF THE DRAWINGS

Various aspects of the invention will be better understood with reference to the detailed description when considered in conjunction with the non-limiting examples and the accompanying drawings, in which:

FIG. 1A is a schematic diagram showing a general procedure to manufacture a metal nanoarray substrate according to various aspects of the invention. As shown in (i), a cross-sectional view of support 105 is provided. A template is formed by attaching a plurality of polymeric nanoparticles, each having a core-shell structure, wherein the core comprises a first polymer 101 and the shell comprises a second polymer 103, to a surface of the support 105. In various embodiments, the polymeric nanoparticles are present as discrete particles on the surface of the support. In (ii), the plurality of polymeric nanoparticles is subjected to an optional treatment step to control or to vary the size of the polymeric nanoparticles. As shown in (iii), the metal nanoarray substrate is formed by contacting the polymeric nanoparticles with metallic nanoparticles 107, such that the metallic nanoparticles 107 are attached to the polymeric nanoparticles of the template as shown in (iv).

FIG. 1B is a schematic diagram showing a procedure to manufacture a metal nanoarray substrate according to certain aspects of the invention. As depicted in the figure, a metal nanoarray substrate comprising gold nanoparticle cluster arrays on a silicon (Si) or glass support is prepared. In the embodiment shown, polymeric nanoparticles comprising the block copolymer polystyrene-b-poly(2-vinylpyridine) (PS-b-P2VP) is used. The polymeric nanoparticles that are attached to the support function as a template to fabricate the gold nanoparticle cluster arrays on the support. In (i), a cross-sectional view of the hemispherical profiles of the polymeric nanoparticles on a support comprising or consisting essentially of silicon or glass is depicted. The polymeric nanoparticles having a core-shell structure, wherein the core comprises a first polymer, poly(2-vinylpyridine), and the shell comprises a second polymer, polystyrene, are attached to a surface of the support to form the template. In the embodiment shown, the plurality of polymeric nanoparticles is also subjected to a treatment in the form of a controlled oxygen (O₂) plasma reactive ion etch (RIE) to vary the template size. Depending on the time of treatment and thickness of the PS shell, for example, the RIE removes some of the PS shell, and may expose the poly(2-vinylpyridine) core. Accordingly, the size of the polymeric nanoparticles is reduced. In (iii), the polymeric nanoparticles are incubated in a solution comprising citrate-stabilized colloidal gold nanoparticles at a pH of 5.8. The pH of the solution is less than the isoelectric point (pI) of 8.3 for the PS-b-P2VP nanoparticles. The inset of the figure shows the electrostatic attraction experienced by the negatively charged gold (Au) nanoparticles to the positively charged polymeric nanoparticles comprising the P2VP core. The Au nanoparticles cluster tightly on the polymeric nanoparticles that are attached to the support to form the metal nanoarray substrate as shown in (iv). The size of the Au nanoparticle clusters may be determined by the feature size, for example, the size of the polymeric nanoparticles and the separation between the polymeric nanoparticles.

FIG. 2 is a graph showing variation in zeta potential of polystyrene-block-poly(2-vinylpyridine) (PS-b-PVP) thin films with the pH of the solution. The isoelectric point (pI) of 8.3 is indicated. Also indicated is the zeta potential of 30.6 mV at a pH of 5.8, which is the pH of the citrate-stabilized gold nanoparticle solution.

FIGS. 3 (a) to (h) are plan-view transmission electron microscopy (TEM) images. FIGS. 3 (a) to (d) are TEM images of measurements taken at high magnifications. FIGS. 3 (e) to (h) are TEM images of measurements taken at low magnifications. The images show gold nanoparticle clusters with increasing number of particles per cluster. The histrograms of the particle numbers per cluster (N) are shown in FIG. 4 (a). The scale bars in FIGS. 3 (a) to (d) depict a length of 100 nm, while those in FIGS. 3 (e) to (h) depict a length of 200 nm.

FIG. 4 (a) are graphs depicting histograms of the number of particles per cluster for four different template sizes, where N=5, 8, 13 and 18. The average number of particles per cluster (N) is shown against each histogram. FIG. 4 (b) is a photograph showing samples of nanoparticle cluster arrays obtained on a glass chip. As can be seen from the photograph, there is variation in hue across the samples, which may be attributed to changes in cluster size. Uniformity across the coated area of the chip is readily discernible from the photograph.

FIG. 5 (a) is a graph showing variation of the number of nanoparticles per cluster (N), as a function of height (R) of the templates. The data is fitted with a quadratic curve of the form y=Cx². In so doing, and in comparing with Equation (c) (see below), the value of C is 0.027. FIG. 5 (b) is a schematic diagram depicting the 3D nature of the gold nanoclusters on the curved hemispherical template with a radius of R. FIG. 5 (c) is a schematic diagram showing characteristic length scales between a pair of nanoparticles in a cluster. The radius of the nanoparticle is denoted as r. The effective radius r_{eff} represents inter-particle separation caused by repulsive interaction due to the presence of negatively charged citrate ligands.

FIGS. 6 (a) and (b) are cross-section and top-view schematic diagrams depicting geometric parameters of (a) templates; and (b) nanoparticle clusters. FIG. 6 (c) is a schematic diagram illustrating the calculation of edge-edge separation between the templates and the clusters from their distributions in the respective geometric parameters (viz. R, d and P). In the figures, P=periodicity of lattice; R=radius of the template; d=2r=diameter of Au nanoparticles (NP); Sₜ=inter-template separation; and S_{d}=inter-cluster separation.

FIG. 7 are tapping mode atomic force microscope (AFM) images of: (a) and (b) templates; (c) and (d) templates with nanoparticles. (a) and (c) are measured under low resolution and (b) and (d) are measured under high resolution. In the images shown, there are systematically increasing separations from left to right. The scale bars in (a) and (c) depict a length of 400 nm, while those in (b) and (d) depict a length of 100 nm.

FIG. 8 are graphs showing extinction spectra of gold nanoparticle cluster arrays with (a) increasing values of N, where N=5, 8, 12 and 18 (a spectrum of isolated gold nanoparticles is also included for reference); and (c) decreasing values of separation, where the separation is 37 nm, 30 nm, 22 nm and 10 nm (their corresponding curves are shown in direction of the arrow).

FIG. 9 are graphs depicting SERS spectra of crystal violet (CV) molecules measured on gold nanoparticle cluster arrays showing signal intensity enhancement with (a) increasing values of N, and (b) decreasing values of inter-cluster separations.

FIGS. 10 (a) and (c) are graphs showing SERS signal intensity for the major peaks of CV molecules comparing intensity enhancement with (a) increases in cluster size N, with N=5, 8, 13 and 18 (arranged in decreasing order from N=18 to N=5, from left to right in the graph), and (b) decreases in cluster separation, where the separation is 37 nm, 30 nm, 22 nm, and 10 nm (arranged in decreasing order from separation=37 nm to separation=10 nm, from left to right in the graph). FIGS. 10 (b) and (d) are graphs comparing intensity and corresponding SERS enhancement factors (EF) of the most intense peak for CV as a function of (b) cluster size; and (d) separation.

FIG. 11 is a bar graph comparing the signal intensity for the most intense peak of the CV molecule obtained on (b) cluster arrays with N=18 and a separation of 10 nm, versus (a) unpatterned gold nanoparticles on silicon substrates (“unpatterned control”), and (c) commercial available Klarite® (Renishaw Diagnostics) substrates as controls. The unpatterned control was obtained by adsorption of citrate stabilized gold nanoparticles on aminosilane treated silicon substrates. As can be seen from the figure, there is a clear increase in SERS performance of the clusters as compared with the controls.

FIG. 12 (a) is a tapping mode atomic force microscope (AFM) image of the template deposited by drop-coating on the tip of a polished optical fiber. The conformal deposition of the reverse micelles on the rough asperities of the surface of the fiber tip is clearly discernable. The scale bar in FIG. 12 (a) denotes a length of 400 nm. FIG. 12 (b) is an optical photograph of the fiber tip covered with gold nanoparticle cluster arrays. The scale bar in FIG. 12 (b) denotes a length of 200 μm. FIG. 12 (c) is an optical photograph showing the area where reflectance spectrum was collected. A microspectrometer measuring a spot of 77 μm×77 μm was used. The scale bar in FIG. 12 (c) denotes a length of 100 μm. FIG. 12 (d) is a graph showing the reflectance spectrum having a plasmonic peak at a wavelength of about 640 nm.

FIG. 13 (a) is a schematic diagram showing the measurement configuration used for measuring SERS on a fiber. FIGS. 13 (b) and (c) are optical photographs showing a measurement set-up that was used to collect signal from a CV solution from one end of the optical fiber, and measured at other. FIG. 13 (c) shows the fiber faucet covered with gold nanoparticle clusters dipped within the CV solution within a vial, while the other end faces the objective lens above.

FIG. 14 are graphs comparing the SERS signal intensity measured under (a) direct configuration; and (b) indirect configuration for the nanoparticle cluster arrays versus unpatterned controls. The unpatterned control includes isolated nanoparticles obtained by electrostatic adsorption of gold nanoparticles to aminosilane treated fiber. The direct measurement configuration measures SERS under backscattering geometry on the fiber tip surface incubated in CV solution overnight. The indirect configuration corresponds to SERS measurements performed through fiber, with the cluster-containing end dipped in solution and the other end facing the objective. FIGS. 14 (c) and (d) are graphs comparing between the most intense peak of the CV molecule obtained in FIGS. 14 (a) and (b) respectively.

FIG. 15 is a graph showing a histogram of nanoparticle diameters obtained from plan-view TEM images, showing average particle size of 11.6 (+/−0.8) nm.

FIG. 16 is a graph showing a systematic reduction in size of the template height with increase in RIE duration. Using the slope of the linear fit line, the etch rate was found to be 19.2 nm.

FIG. 17 (a) to (d) are tapping mode atomic force microscopy (AFM) images of templates with systematically increasing heights from (a) to (d). The templates are obtained from (a) 38 s; (b) 30 s; (c) 22 s; and (d) Os of oxygen (O₂) plasma reactive ion etch (RIE) treatment on the surface of PS-b-P2VP films. The curves show the size distribution of the templates, obtained by Gaussian fits made to histograms of heights obtained from AFM measurements. The scale bar in the figures denotes a length of 100 nm.

FIG. 18 (a) to (d) are field emission scanning electron microscopy (FESEM) images of gold nanoparticle cluster arrays obtained using different template dimensions realized through controlled O₂ plasma RIE durations as indicated in the figures. The scale bar in the figure denotes a length of 200 nm.

FIG. 19 (a) is a block diagram illustrating the steps used for extraction of 3D coordinates using TEM plan view images of the nanoparticle clusters. FIG. 19 (b) is a series of images of (i) plan-view TEM image of nanoparticle clusters where N is about 13; (ii) plan-view TEM image of a single cluster arbitrarily chosen and sectioned; and (iii) image of (ii) thresholding to subtract background. The (x, y) coordinates of each Au nanoparticle is obtained with respect to the chosen origin, with the distances known through magnification of the TEM image. FIG. 19 (b) (iv) is an image depicting planes with different z heights of isolated nanoparticles obtained by background subtraction. Each sectioned nanoparticle template is then uploaded in the finite difference time domain (FDTD) simulation layout that contains polystyrene hemispheres on the silicon substrate. The z coordinate of the particle is computed from the point of intersection of the gold nanoparticle and the polystyrene hemisphere. The FDTD layout made from the extracted (x, y, z) data of each nanoparticle in sectioned cluster is illustrated to the right in FIG. 19 (c).

FIG. 20 (a) to (d) are graphs depicting simulated extinction spectra for different cluster sizes (N), where (a) N has a value of about 5; (b) N has a value of about 8; (c) N has a value of about 13; and (d) N has a value of about 18. The separation values are respectively (a) 61.0 nm; (b) 53.3 nm, (c) 45.5 nm and (d) 33.7 nm.

FIG. 21 is a graph showing a simulated extinction spectrum of N having a value of about 18 clusters, after removing the periodic boundary condition showing that the sharp feature about 450 nm appearing in the periodic clusters is absent. In addition, a contribution around 520 nm appears, along with a weak modulation around about 650 nm.

FIG. 22 are E-field profiles of (A) 3D clusters; and (B) imaginary planar clusters performed for the case where N is about 18. The simulation shows that the 3D clusters exhibit an E-field enhancement across a wide area spanning the entire inter-cluster region. This is however found to be absent in the planar clusters. The scale bar in the images denotes a length of 10 nm.

FIG. 23 is a graph depicting the simulated extinction spectra of N-18 clusters, obtained by modeling Au nanoparticles that are 50% immersed within the polystyrene template. The simulated spectrum (as shown in FIG. 24) shows a dominant contribution at 530 nm due to individual excitation of Au particles, but the peak around 600 nm (as observed in the clusters) due to plasmonic coupling between nanoparticles is absent.

FIG. 24 is a graph depicting the SERS spectra of CV acquired at 12 different locations spaced at least 3 mm apart on substrate, which are overlaid to show the signal intensity variation. The most intense peak of CV at 1617 cm⁻¹ is used to compute the error, which in this case is 8.5%.

FIGS. 25 (a) and (b) are graphs comparing the SERS signal intensity for the most intense peak of CV of the nanoparticle cluster arrays with systematic variation in (a) cluster sizes and (b) inter-cluster separations against unpatterned gold nanoparticle monolayer as control.

FIG. 26 is a graph depicting the SERS spectra of (b) CV molecule on cluster array substrates compared against (a) unpatterned gold monolayer used as a control.

FIG. 27 is a schematic diagram illustrating the divergent electrical field emanating from the nanoparticle clusters expected due to the curved geometry.

FIG. 28 are graphs showing (a) systematic variation in curvature (or height (h) to radius (R) ratio) of the reverse micelle templates on surface, as a function of relative humidity of the environment during thin film formation; (b) systematic variation in the plasmon resonance of nanoparticle cluster arrays with variations in the h/R ratio. The fine-tunability in curvature is a possibility that arises with a composite core-shell system such as the reverse micelles. The change arises due to the possible increase in surface tension at the interface of polystyrene and polyvinyl pyridine, due to absorption of moisture within PVP, to the extent there is moisture content in the surrounding environment during the formation of templates on surface. Such fine-tunability in curvature is found to yield tunability in plasmon resonance, and it is a significant capability of interest to achieve higher SERS performance of the resulting arrays. There is a possibility of fine-tuning the plasmon resonance close to the molecular absorbance, and the laser excitation wavelength used in order to realize high SERS enhancements.

FIG. 29 depicts super-cluster arrays of gold (Au) nanoparticle clusters with systematically varying structural composition achieved through control over deposition conditions, and by varying the relative humidity during spin-coating. ‘A’ refers to in situ prepared Au nanoparticles obtained from polystyrene-block-poly(2-vinylpyridine) with a molecular weight of 380 kDa, with f_{PS}˜0.5. ‘B’ refers to reverse micelle templates formed out of PS-b-P2VP 114 kDa and f_{PS}˜0.5. ‘C’ refers to citrate-stabilized Au nanoparticles adsorbed from solution phase. The scale bar in the figures denotes a length of 100 nm.

FIG. 30 are graphs showing removal of the supporting polymer template results in higher SERS enhancements as could be expected due to a closer separation between nanoparticles, contrary to earlier beliefs that the nanoparticles formed a fused mass by coalescing together. All spectra were recorded under identical conditions of probe molecule deposition, laser excitation wavelength, exposure duration and laser power. The SERS enhancement was found to distinctly increase upon removal of the polymer template as shown in FIG. 30 (a). The enhancement further increased upon formation of a super-cluster (with polymer removed), as shown in FIG. 30 (b). The influence on the SERS enhancement due to super-cluster formation may have contributions from the central gold nanoparticle template, along with the complex plasmonic coupling due to the super-cluster geometry. The scale bar in the figure denotes a length of 100 nm.

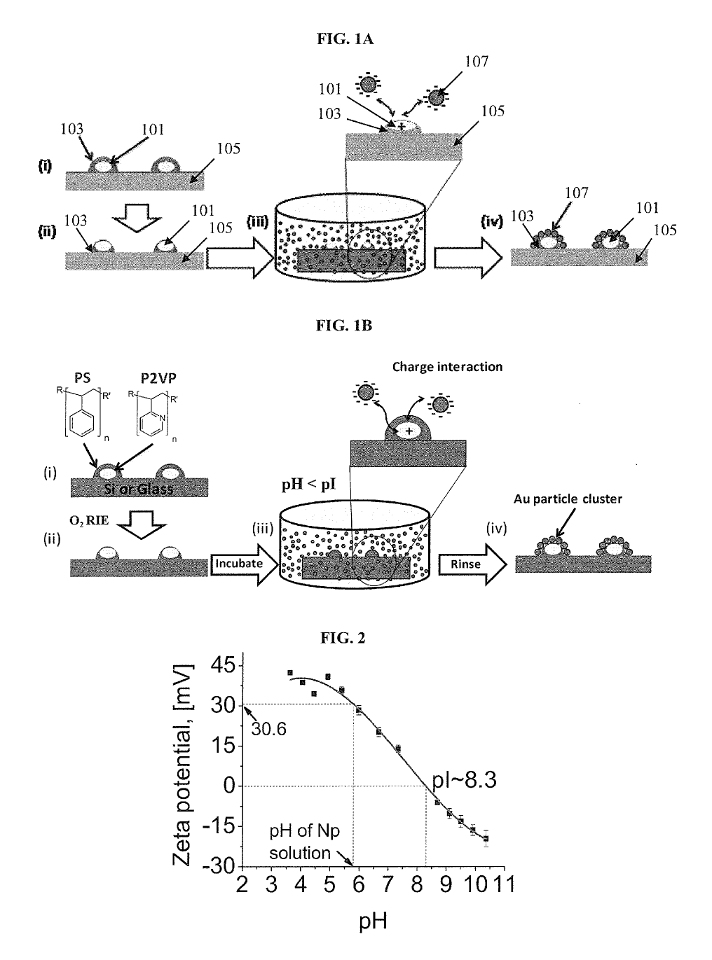

### DETAILED DESCRIPTION OF THE INVENTION

In a first aspect, the present invention refers to a method of manufacturing a metal nanoarray substrate. The method comprises, in some embodiments, providing a support; forming a template by attaching a plurality of polymeric nanoparticles some or all having a core-shell structure to the support, wherein the core comprises a first polymer and the shell comprises a second polymer; and forming the metal nanoarray substrate by attaching a plurality of metallic nanoparticles to at least some of the polymeric nanoparticles of the template.

Through methods such as the first aspect of the invention, a substrate that may be used for optical sending by surface enhanced Raman spectroscopy (SERS) is obtained. By attaching a plurality of polymeric nanoparticles having a core-shell configuration on a suitable support, a template for subsequent attachment of metallic nanoparticles may be formed. In various embodiments, the core of the polymeric nanoparticles comprises or is formed from a first polymer that exhibits an electric charge when present in an aqueous solution. Depending on the type of the first polymer and/or the pH of the solution, for example, the charge on the first polymer may be positive or negative. In various embodiments, the core of the polymeric nanoparticles comprises or is formed from a first polymer having an isoelectric point that is higher than the pH of the solution comprising the metallic nanoparticles. By placing the support in a solution having a pH that is lower than the isoelectric point of the first polymer, the polymeric nanoparticles, which are attached to the support, may attain a positive charge. Subsequently, when metallic nanoparticles, for example, negatively charged metallic nanoparticles such as citrate-stabilized gold nanoparticles, are brought into contact with the polymeric nanoparticles, the metallic nanoparticles may be attracted to the polymeric nanoparticles, and may be attached to the polymeric nanoparticles by electrostatic interaction.

An advantage of a substrate formed by such methods is that no lithography or electron beam lithography is involved, thus providing a simple, inexpensive and quick technique to achieve a highly sensitive and spatially uniform SERS signal, e.g., for biomedical applications. A treatment step, such as wet etching or dry etching, may be used to treat the polymeric nanoparticles that are attached to the surface of the support to vary the template size. In so doing, the resolution of the template, such as the size of the polymeric nanoparticles and the interparticle distance between the polymeric nanoparticles, may be customized in a simple manner. Using such methods, highly uniform, precise and well-defined metallic arrays of sub-5 nm separations may be achieved. Furthermore, such methods to form the substrate may be advantageous in that no linkers are required to attach the metallic nanoparticles to the polymeric nanoparticles attached on the support. Instead, the metallic nanoparticles may directly attach to the polymeric nanoparticles by electrostatic attraction, thereby eliminating extra process steps. In further embodiments, the treatment step may be used to remove the polymeric template. In so doing, a metal nanoarray substrate of arrays of metallic nanoparticles clusters (termed herein as “super-clusters”) on a support may be formed.

A substrate for optical sensing by SERS, herein also termed a SERS substrate, generally refers to an engineered metallic nanostructure on which analyte molecules are adsorbed for SERS acquisitions. Various embodiments of the present invention relate to a SERS substrate that provides a highly uniform and reproducible bioanalysis surface.

Generally, a SERS substrate includes a support having a roughened metal surface, in which the degree of roughness of the metal surface is sufficient to induce the SERS effect. The degree of roughness of the metal surface may result in a reproducible and uniform SERS signal, such as within about 10% reproducibility error variation over a substrate area of 1 cm², for analysis of materials bound to the metal surface of the substrate. In various embodiments, the SERS signal intensity variations are as low as 10%.

Such methods may comprise providing a support. The support used to form the SERS substrate may generally be formed from any material. Examples of material that may be used to form the SERS substrate include, but are not limited to, silicon, glass, ceramic and organic polymers. In some embodiments, the support is silicon or glass.

Such methods may comprise forming a template by attaching a plurality of polymeric nanoparticles having a core-shell structure to a surface of the support. A “nanoparticle” refers to a particle having a characteristic length, such as diameter, in the range of up to 100 nm. The term “polymeric nanoparticles” refers to nanoparticles that comprise one or more different polymers. The term “plurality” as used herein means more than one, such as at least 2, 20, 50, 100, 1000, 10000, 100000, 1000000, 10000000 or even more.

The plurality of polymeric nanoparticles that is attached to the support surface functions as a template for subsequent attachment of a plurality of metallic nanoparticles on the polymeric nanoparticles. Using such methods, it has been found that the templates formed, for example, on a silicon wafer support, may be highly uniform, e.g., with standard deviations in the mean values for feature heights, and spacing of less than 10% (as measured by AFM).

The template size and geometry may be controlled by controlling the size and geometry of the polymeric nanoparticles by controlling the molecular weight of the polymer or the polymeric nanoparticle-forming conditions. For example, control of the polymeric nanoparticle-forming conditions may comprise control of the relative humidity during polymeric nanoparticle formation. In various embodiments, the relative humidity during polymeric nanoparticle formation is controlled to be in the range of between about 10% to about 90%, such as about 10% to about 50%, about 10% to about 30%, about 50% to about 90%, or about 30% to about 50%.

The plurality of polymeric nanoparticles may have a core-shell structure. The core of the core-shell polymeric nanoparticles may comprise a first polymer, and the shell of the polymeric nanoparticles may comprise a second polymer.

To form the core-shell polymeric nanoparticles, in various embodiments, a first polymer is used to form nanoparticles, followed by deposition of a second polymer on the nanoparticles. In so doing, a plurality of polymeric particles having a core-shell structure, wherein the core comprises the first polymer and the shell comprises the second polymer, may be formed. Nanoparticles comprising the first polymer may be formed, for example, by dispersing the first polymer in a suitable medium to form an emulsion containing nanoparticles of the first polymer. By coating the second polymer on the nanoparticles, such as by immersing the nanoparticles in a solution comprising monomers of the second polymer, followed by polymerization of the monomers, a plurality of polymeric nanoparticles having a core-shell structure may be obtained.

The first polymer may be a polymer that is able to exhibit an electric charge, such as a positive charge or a negative charge. The first polymer may be charged during synthesis of the polymer, and/or in solution prior to formation of the templates on a surface of the support. In various embodiments, the first polymer exhibits an electric charge when present in an aqueous solution. Depending on the type of the first polymer and/or the pH of the solution, for example, the charge on the first polymer may be positive or negative. The electric charge on the first polymer may attract oppositely charged metallic nanoparticles by, for example, electrostatic attraction. Depending on the type of metallic nanoparticles for adsorption, and/or the charge type present on the metallic nanoparticles, different polymers may be used. For example, when positive charged metallic nanoparticles are used, the first polymer may be polyacrylic acid, which may acquire a negative charge in an aqueous medium (at a pH of greater than about 4.5), capable of attracting gold (Au) nanoparticles functionalized with a positively charged ligand. Other types of first polymer that exhibit a negative charge in aqueous medium, which may be dependent on the pH of the solution, may be used.

As another example, in embodiments in which negatively charged citrate-stabilized Au nanoparticles are used, the first polymer may be a polymer that exhibits a positive charge. The first polymer may be a polymer that exhibits a positive charge in an aqueous medium having a pH of less than about 8. In various embodiments, the first polymer may comprise a unit selected from the group consisting of vinyl pyridine, N-(3-aminopropyl)methacrylamide (APMA), N-(3-dimethylaminopropyl)methacrylamide, methacrylamidopropyl trimethylammonium chloride, aminostyrene, ornithine, lysine, amidines, guanidines, hydrazines, phosphonium salts, and mixtures thereof. In various embodiments, the first polymer comprises poly(2-vinyl pyridine), which possesses a vinyl pyridine unit. In some embodiments, the first polymer is poly(2-vinyl pyridine).

Generally, the second polymer may comprise any polymer that can form a shell on the core comprising the first polymer. In some embodiments, the second polymer comprises a hydrophobic unit. Examples of such polymers include, but are not limited to, polystyrene, polyolefin, polysiloxane, polyvinyl naphthalene, polyvinyl anthracene, and mixtures thereof. In some embodiments, the second polymer comprises polystyrene. In one embodiment, the second polymer is polystyrene.

As mentioned above, the first polymer and the second polymer may be formed independently and processed to form the core and the shell of the plurality of polymeric nanoparticles, although other techniques may also be used to form core-shell polymeric nanoparticles. For example, in various embodiments, the plurality of polymeric nanoparticles may be formed by copolymerizing the first polymer and the second polymer to form an amphiphilic copolymer, and dispersing the amphiphilic copolymer in a suitable organic solvent to form reverse micelles. In some embodiments, the polymeric nanoparticles are reverse micelles. In these embodiments, the second polymer may be any suitable polymer that presents a surface energy contrast with the first polymer to allow formation of micelles in solution that can be deposited on the support surface to form templates.

Reverse micelles, also referred to herein as inverted micelles, is defined as an orientation of amphiphiles in an aggregate structure whereby the non-polar hydrophobic tails of the amphiphiles are directed outward into the organic solvent while the polar hydrophilic heads point inward. As the name implies, in such an orientation, reverse micelles are opposite to the features of normal micelles in water. Examples of organic solvents that may be used include, but are not limited to, xylene, toluene, mesitylene, benzene, pyridine, tetrahydrofuran, pentane, hexane, heptane, octane, nonane, decane, undecane, dodecane, tridecane, tetradecane, pentadecane, hexadecane, and mixtures thereof.

For example, the first polymer and the second polymer may be linked to form a block copolymer of polystyrene and poly(2-vinylpyridine) (PS-b-P2VP). When PS-b-P2VP block polymer is dispersed in an organic solvent, such as m-xylene, the PS-b-P2VP block polymer may form a reverse micelle in the solvent, whereby the hydrophilic P2VP end of the block polymer constitutes the core of the reverse micelle, and the hydrophobic PS end of the block polymer constitutes the outer portion of the reverse micelle. Accordingly, the polymeric nanoparticles that is used to form the template may comprise or consist essentially of a block copolymer of polystyrene and poly(2-vinylpyridine).

Generally, the reverse micelles formed are spherical in shape (although other shapes are possible), as such configurations minimize surface energy. The reverse micelles dispersed in an organic solvent may be coated on a support using any suitable thin film coating method. Examples of thin film coating methods include painting, spin coating, drop coating, tip coating, screen printing and sol gel deposition. In various embodiments, spin coating is used to form the polymeric nanoparticles on the support. In embodiments in which the support is an optical fiber, drop coating may be used.

Use of an amphiphilic copolymer to form reverse micelles for nanopattern formation on a support offers advantages such as specific nanoscale geometry for template size and separation. As mentioned above, the template size and geometry may be controlled by controlling the size and geometry of the polymeric nanoparticles by controlling the molecular weight of the polymer or the polymeric nanoparticle-forming conditions. For example, the size of the template may be varied by using smaller micelles, which may be obtained using a copolymer with smaller molecular weight, micelle formation conditions that result in a smaller aggregation number, or both. In one embodiment, PS-b-P2VP reverse micelle arrays may be formed using PS-b-P2VP copolymers having a molecular weight of about 114 kDa. Furthermore, by varying moisture content or humidity in the surrounding environment during formation of the templates on the support surface, the curvature of the reverse micelle template on the support may be tuned in some embodiments due to increases in surface tension at the interface of the first polymer and the second polymer that constitutes the reverse micelles. Another advantage of certain embodiments relating to the formation of templates using reverse micelles lies in that the reverse micelles formed may be attached in a simple and straightforward manner using conventional thin film coating methods to generate a template on a support for subsequent attachment of the metallic nanoparticles.

The template of the core-shell polymeric nanoparticles may be contacted with a plurality of metallic nanoparticles, such that the metallic nanoparticles attach to the polymeric nanoparticles to form a metal nanoarray substrate. The nanopatterned polymeric nanoparticles that are attached to the support may allow for formation of controlled aggregates of the metallic nanoparticles, which may result in a very low variation in the surface features of the substrate.

The polymeric nanoparticles may be irregular or regular in shape. In some embodiments, the metal nanoparticles are regular in shape. For example, the polymeric nanoparticles may assume a spherical shape. Accordingly, the polymeric nanoparticles may be nanospheres.

The size of the nanoparticles may be characterized by their mean diameter. The term “diameter” as used herein refers to the maximal length of a straight line segment passing through the center of a figure and terminating at the periphery. Accordingly, the term “mean diameter” refers to an average diameter of the nanoparticles, and may be calculated by dividing the sum of the diameter of each nanoparticle by the total number of nanoparticles. Although the term “diameter” is used normally to refer to the maximal length of a line segment passing through the centre and connecting two points on the periphery of a nanosphere, it is also used herein to refer to the maximal length of a line segment passing through the center and connecting two points on the periphery of nanoparticles having other shapes, such as a nanocube.

Although polymeric nanoparticles having a mean diameter in the sub-micron or micron range may be used, it is advantageous in certain embodiments for polymeric nanoparticles having a mean diameter in the nanometer range to be used, in order to generate SERS substrates having a greater number of nanoparticle cluster features for analysis. The polymeric nanoparticles may have a mean diameter that is less than 200 nm, such as in the range from about 10 nm to about 100 nm, or about 10 nm to about 50 nm. In various embodiments, the polymeric nanoparticles have a mean diameter in the range of about 30 nm to about 200 nm. In one specific embodiment, the polymeric nanoparticles have a mean diameter of about 30 nm to about 60 nm, for example about 40 nm.

Advantageously, the method according to various embodiments may be used to attach a plurality of polymeric nanoparticles to a support surface to form an array having an average inter-particle distance of less than 50 nm on the support, such as less than 40 nm, less than 30 nm, less than 20 nm or less than 10 nm. In one embodiment, the plurality of polymeric nanoparticles forms an array having an average inter-particle distance of about 10 nm on the support.

The size of the template may be varied by subjecting the polymeric nanoparticles that are attached to the support surface to a treatment. Generally, any method that is able to remove at least a portion of the shell of the polymeric nanoparticles, thereby changing the size of the template, may be used. In various embodiments, the treatment may also remove a portion of the core of the polymeric nanoparticles to form smaller polymeric nanoparticles. In various embodiments, the polymeric template comprising the polymeric nanoparticles may be removed by the treatment. The treatment may include any suitable physical or chemical technique. In some embodiments, the treatment comprises dry etching or wet etching. Examples of dry etching include, but are not limited to, plasma etching, sputter etching, and reactive ion etching. In one embodiment, the treatment comprises reactive ion etching.

The amount of time for treating the plurality of polymeric nanoparticles may vary depending on the resolution of the template required. In embodiments where a non-charged shell is used, the amount of time for treating the polymeric nanoparticles may be varied to remove a portion of the non-charged shell in order to allow attachment of the metallic nanoparticles on the polymeric nanoparticles by electrostatic interaction. In various embodiments where reactive ion etching is used, oxygen plasma may be used. The duration of plasma exposure may be in the range of about 15 s to about 50 s, such as about 20 s to about 40 s, about 20 s, 30 s, or about 40 s.

In certain embodiments, such methods include subjecting a plurality of metallic nanoparticles to the exposed cores of the polymeric nanoparticles of the template to form the metal nanoarray substrate.

As mentioned above, the core of the polymeric nanoparticles may comprise or may be formed from a first polymer exhibiting an electric charge when present in an aqueous solution. For example, the core of the polymeric nanoparticles may comprise or may be formed from a first polymer having an isoelectric point that is higher than the pH of the solution comprising the metallic nanoparticles. By placing the support in a solution having a pH that is lower than the isoelectric point of the first polymer, the polymeric nanoparticles, which are attached to the support, may attain a positive charge. Subsequently, when metallic nanoparticles, for example, negatively charged metallic nanoparticles, are brought into contact with the polymeric nanoparticles, the metallic nanoparticles may be attracted to the positively charged polymeric nanoparticles, and may be attached to the polymeric nanoparticles by electrostatic interaction.

The term “metallic nanoparticles” refers to a nanoparticle that comprises a SERS active metal. Examples of a SERS active metal include, but are not limited to, noble metals such as silver, palladium, gold, platinum, iridium, osmium, rhodium, ruthenium, copper, and alloys thereof.

In some embodiments, the metallic nanoparticles comprises or consists essentially of one or more noble metals. In one embodiment, the noble metal is gold. In some embodiments, the metallic nanoparticles comprise a noble metal. For example, the metallic nanoparticles may have a core-shell structure, in which the core of the metallic nanoparticles may be formed from any material such as a polymer or glass, and the shell of the metallic nanoparticles may comprise or may be formed from one or more noble metals. In various embodiments, the metallic nanoparticles comprise or consist essentially of gold. In one specific embodiment, the metallic nanoparticles are gold nanoparticles.

The metallic nanoparticles may be present as colloidal metal nanoparticles in solution. In one specific embodiment, gold nanoparticles prepared by the Turkevich method, which involves citrate reduction of chloroauric acid, are used. To inhibit the metallic nanoparticles from aggregating in solution, negatively charged metallic nanoparticles may be used. In some embodiments, the negatively charged metallic nanoparticles are metal nanoparticles carrying a negative charge at the nanoparticle surface.

Metallic nanoparticles with a negative surface charge may be nanoparticles in which the negative charge of the metallic nanoparticles is conferred by a carboxylic acid, sulfonic acid, carbolic acid or a mixture of the aforementioned acids which is immobilized at the surface of the metallic nanoparticles. For example, the carboxylic acid may be, but is not limited to, citric acid, lactic acid, acetic acid, formic acid, oxalic acid, uric acid, pyrenedodecanoic acid, mercaptosuccinic acid, aspartic acid, to name only a few.

In one specific embodiment, citric acid is used to form negatively charged gold nanoparticles comprising a surface layer of citrate ions. For example, the metallic nanoparticles may be citrate-stabilized gold nanoparticles. Due to the presence of citric acid, the pH of the colloidal gold nanoparticles solution may be acidic, or weakly acidic. For example, the pH of the colloidal gold nanoparticles solution may be less than 7, for example, less than 6.5 or less than 6. In one embodiment, the pH of the citrate-stabilized gold nanoparticle solution is about 5.8.

In various embodiments, the metallic nanoparticles that are attached to the polymeric nanoparticles of the template are negatively charged metallic nanoparticles. The metallic nanoparticles may be attached to the polymeric nanoparticles by electrostatic interaction. The term “electrostatic interaction” as used herein refers to attraction between electrically charged molecules, such as between a negatively charged molecule and a positively charged molecule. The electrostatic interaction between the metallic nanoparticles and the polymeric nanoparticles may arise from the positively charged polymeric nanoparticles that are attached to the support and the negatively charged metallic nanoparticles, or vice versa.

As mentioned, the first polymer may have an isoelectric point that is higher than the pH of the solution comprising the metallic nanoparticles. The term “isoelectric point” refers generally to the pH of the solution at which a particular molecule or surface carries no net electrical charge. Thus, the isoelectric point may refer to the pH of the solution at which the net charge of the first polymer is zero. Accordingly, when placed in a solution at which the pH is less than its isoelectric point, the first polymer may attain a positive charge. Even though the first polymer may be present in the core of the polymeric nanoparticles and encapsulated by a non-charged shell comprising a second polymer, electrostatic attraction may also occur through the non-charged shell. As mentioned above, an optional treatment may be used to remove a portion of the non-charged shell, e.g., to allow attachment of the metallic nanoparticles on the polymeric nanoparticles by electrostatic interaction. Depending on the type of treatment and the treatment time, the non-charged shell may be substantially removed to expose the core comprising the first polymer. In various embodiments, the first polymer exhibits a positive charge in an aqueous medium having a pH of less than about 8. In one embodiment, the aqueous medium having a pH of less than about 8 comprises a gold colloidal solution having a pH of about 5.8.

The metallic nanoparticles may be irregular or regular in shape. In some embodiments, the metallic nanoparticles are regular in shape. For example, the metallic nanoparticles may have a regular shape such as a sphere, a cube or a tetrahedron. Accordingly, the nanoparticles may be nanospheres, nanocubes, nanotetrahedra, etc. In some embodiments, the metallic nanoparticles are spherical in shape. The metallic nanoparticles may also be of other anisotropic-shaped particles.

The metallic nanoparticles may have a smaller mean diameter than that of the polymeric nanoparticles. The metallic nanoparticles may have a mean diameter of about 2 nm to about 50 nm, such as about 2 nm to about 50 nm, about 2 nm to about 20 nm, about 2 nm to about 10 nm, about 5 nm to about 10 nm, or about 4 nm to about 6 nm. In some embodiments, the metallic nanoparticles have a mean diameter of about 10 nm. In one specific embodiment, the metallic nanoparticles have a mean diameter of about 5 nm to about 15 nm, for example about 5 nm.

In some embodiments, the metallic nanoparticles may have the same shape as the polymeric nanoparticles. For example, the polymeric nanoparticles and the metallic nanoparticles may both be nanospheres. In some embodiments, the polymeric nanoparticles and the metallic nanoparticles have different shapes. For example, the polymeric nanoparticles may be irregularly shaped and the metallic nanoparticles may be nanospheres.

The support may comprise a planar surface onto which the plurality of polymeric nanoparticles is attached. For example, the support may be in the form of a flat sheet, or a cuboid, or the planar side of a hemisphere. The support may also assume other shapes, such as a cylinder, a sphere, a hemisphere, a pyramid, a diamond, or may be irregularly shaped. Accordingly, the surface of the support wherein the plurality of polymeric nanoparticles is attached to may be non-planar. In some embodiments, the support comprises an optical fiber. In such embodiments, the polymeric nanoparticles may be attached to the optical fiber by drop coating. In so doing, an even smaller inter-particle distance or separation compared to that using spin coating, for example, may be obtained.

The plurality of polymeric nanoparticles and/or metallic nanoparticles may essentially be monodisperse. The term “monodisperse” refers to nanoparticles having a substantially uniform size and shape. In some embodiments, the standard deviation of diameter distribution of the polymeric nanoparticles of the template is equal to or less than 20% of the mean diameter value, such as equal to or less than 15%, 10%, 5% or 3% of the mean diameter value. In some embodiments, the diameter of the polymeric nanoparticles is essentially the same.

Likewise, the standard deviation of diameter distribution of the metallic nanoparticles may be equal to or less than 20% of the mean diameter value, such as equal to or less than 15%, 10%, 5% or 3% of the mean diameter value. In some embodiments, the diameter of the metallic nanoparticles is essentially the same.

The metallic nanoparticles attached to the polymeric nanoparticles may have an inter-particle distance of less than 5 nm, such as less than 4 nm, less than 3 nm, less than 2 nm or less than 1 nm. The average number of metallic nanoparticles on each polymeric nanoparticle may be in the range of about 1 to about 25 (e.g., 1, 2, 3, 4, 5, 6, 7, 8, 9, 10, 11, 12, 13, 14, 15, 16, 17, 18, 19, 20, 21, 22, 23, 24 or 25), and may depend on the size of the template, for example, the surface area of the polymeric nanoparticles. Generally, the larger the surface area of the polymeric nanoparticles, the larger the number of metallic nanoparticles that may be attached to. In one embodiment, the average number of metallic nanoparticles on each polymeric nanoparticle is about 18.

Besides the use of a support having a planar or a non-planar surface onto which the plurality of polymeric nanoparticles may be attached, the support may further comprise a metallic nanoparticle attached to the surface of the support, wherein the metallic nanoparticle is formed by first forming a polymeric nanoparticle, contacting the polymeric nanoparticle with a solution containing metal ions, and removing the polymer, thereby forming metallic nanoparticles in situ. The term “a metallic nanoparticle” as used herein may refer to one or a plurality of metallic nanoparticles. Likewise, the term “a polymeric nanoparticle” as used herein may refer to one or a plurality of polymeric nanoparticles.

Examples of polymeric nanoparticles and metallic nanoparticles that may be used have already been described above. In various embodiments, the metallic nanoparticle is a gold nanoparticle. In various embodiments, the polymeric nanoparticle comprises or consists essentially of a block copolymer of polystyrene and poly(2-vinylpyridine).

The solution containing metal ions may be an aqueous solution containing gold ions. For example, the aqueous solution containing gold ions may comprise chloroauric acid, tetrachloroauric acid, a lithium salt of tetrachloroauric acid, a sodium salt of tetrachloroauric acid, a potassium salt of tetrachloroauric acid, tetrabromoauric acid, a lithium salt of tetrabromoauric acid, a sodium salt of tetrabromoauric acid, a potassium salt of tetrabromoauric acid, tetracyanoauric acid, a sodium salt of tetracyanoauric acid and a potassium salt of tetracyanoauric acid. In one embodiment, the aqueous solution containing gold ions comprises or consists essentially of chloroauric acid.

The metal ions may concentrate within the polymeric nanoparticles. In various embodiments, the metal ions may concentrate within the core comprising the first polymer of the polymeric nanoparticles. Subsequently, the polymer may be removed by reactive ion etching. In so doing, the metal ions that are within the polymeric nanoparticles may undergo reduction, thereby forming metallic nanoparticles in situ.

In further embodiments, formation of the template may be carried out by attaching a plurality of polymeric nanoparticles, some or all having a core-shell structure, to the metallic nanoparticles that are attached to the surface of the support. For example, after formation of the metallic nanoparticles in situ on the support, a plurality of polymeric nanoparticles, some or all having a core-shell structure such as that described above, may be attached to the metallic nanoparticles to form the template.

In yet further embodiments, formation of the metal nanoarray includes attaching a plurality of metallic nanoparticles to the polymeric nanoparticles of the template, and then additional metallic nanoparticles may optionally be attached to the surface of the support. For example, after attachment of a plurality of polymeric nanoparticles to the metallic nanoparticles, which may be formed in situ on the support, a plurality of metallic nanoparticles may be attached to both the polymeric nanoparticles and the metallic nanoparticles attached to the surface of the support. In some embodiments, formation of the template is carried out by attaching a plurality of polymeric nanoparticles, some or all having a core-shell structure, directly to the surface of the support.

In some aspects, the invention refers to a metal nanoarray substrate obtained by a method such as is described herein.

In another aspect, the invention refers to a biosensor comprising a metal nanoarray substrate manufactured by a method such as is described herein. The biosensor can be configured for in vivo and/or in vitro use.

In another aspect, the invention refers to a method for the detection of an analyte in a sample by SERS. The method may comprise contacting the sample with the biosensor according to aspects such as those described herein.

The term “detection” as used herein refers to a method of verifying the presence of a given molecule. The detection may be qualitative, and/or the detection may also be quantitative. The detection may include correlating the detected signal with the amount of analyte. The detection includes in vitro as well as in vivo detection.

The term “analyte” as used herein refers to any substance that can be detected in an assay and which may be present in a sample. The analyte may, for example, be an antigen, a protein, a polypeptide, a nucleic acid, a hapten, a carbohydrate, a lipid, a cell or any other of a wide variety of biological or non-biological molecules, complexes or combinations thereof. Generally, the analyte will be a protein, peptide, carbohydrate or lipid derived from a biological source such as bacterial, fungal, viral, plant or animal samples. Additionally, however, the analyte may also be a small organic compound such as a drug, drug-metabolite, dye or other small molecule present in the sample.

The term “sample”, as used herein, refers to an aliquot of material, frequently biological matrices, an aqueous solution or an aqueous suspension derived from biological material. Samples to be assayed for the presence of an analyte by the methods of the present invention include, for example, cells, tissues, homogenates, lysates, extracts, and purified or partially purified proteins and other biological molecules and mixtures thereof.

Non-limiting examples of samples typically used in the methods of the invention include human and animal body fluids such as whole blood, serum, plasma, cerebrospinal fluid, sputum, bronchial washing, bronchial aspirates, urine, semen, lymph fluids and various external secretions of the respiratory, intestinal and genitourinary tracts, tears, saliva, milk, white blood cells, myelomas and the like; biological fluids such as cell culture supernatants; tissue specimens which may or may not be fixed; and cell specimens which may or may not be fixed. The samples may vary based on the assay format and the nature of the tissues, cells, extracts or other materials, especially biological materials, to be assayed. For example, methods for preparing protein extracts from cells or samples are well known in the art and can be readily adapted in order to obtain a sample that is compatible with the methods of the invention. Detection in a body fluid can also be in vivo, e.g., without first collecting a sample.

By contacting the biosensor with the analyte containing medium, for example a sample or body fluid, and detecting the SERS signal from the sensor, the presence of the analyte may be detected. Examples of bodily fluids that may be used include, but are not limited to, plasma, serum, blood, lymph, liquor and urine.

The methods for the detection of an analyte in a sample by SERS may include, in some embodiments, contacting the sample with one or more Raman reporters. The term “Raman reporters” refers to compounds which have a high Raman cross-section and where the Raman vibrational “fingerprint” is detectably altered, for example by a shift and/or an increase in intensity, upon the binding of an analyte, so as to allow detection and/or quantification of the analyte. Accordingly, the compounds can also be considered to represent reporters or receptors of the analyte.

The Raman reporter compounds may bind with the analyte and may be stably adsorbed at a surface that enhances the Raman signal from the compounds, such as a substrate, according to various embodiments of the invention, by reversible electrostatic interaction, hydrophobic interaction or covalent anchoring. Preferably, the compounds have a high Raman cross-section and the capability to adsorb strongly on the surface of the metal nanoparticles so that it gives a fast and intense and non fluctuating SERS signal that is proportional to the concentration of the analyte in bulk. Accordingly, by carrying out SERS measurements on the SERS substrate, the presence and/or quantity of an analyte in a sample may be determined.

The use of a biosensor according to various embodiments of the invention is advantageous in that the SERS-based detection methods of the invention may be suitable for multiplexing, which is important, for example, in the context of sensing experiments, to understand complex mechanistic pathways in biological studies and in personalized medicine. Furthermore, the use of noble metals, which are biocompatible, in metal nanoparticles according to various embodiments, means that analyte detection can be carried out under physiological conditions, and the sensing components can be integrated in a minimally invasive platform, such as optical fibers or implantable devices.

Examples of application areas in which a substrate manufactured by a method of the invention may be used include, but are not limited to, analytical devices based on localized surface plasmon resonance (LSPR), surface enhanced Raman spectroscopy (SERS), metal enhanced fluorescence (MEF), optical communication devices such as plasmonic waveguides, lighting devices, solar cells, and photocatalytic devices.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although various inventions have been specifically disclosed by preferred embodiments and optional features, modification and variation of the inventions embodied therein herein disclosed may be resorted to by those skilled in the art, and that such modifications and variations are considered to be within the scope of these inventions.

Various inventions have been described broadly and generically herein. Each of the narrower species and subgeneric groupings falling within the generic disclosure also form part of the inventions. This includes the generic description of the inventions with a proviso or negative limitation removing any subject matter from the genus, regardless of whether or not the excised material is specifically recited herein.

Other embodiments are within the following claims and non-limiting examples. In addition, where features or aspects of the inventions are described in terms of Markush groups, those skilled in the art will recognize that the invention is also thereby described in terms of any individual member or subgroup of members of the Markush group.

### EXPERIMENTAL SECTION

### Example 1

### Materials

Polystyrene-block-poly(2-vinylpyridine) (PS-b-PVP) (57000-b-57000 g/mol) was purchased from Polymer Source Inc. (Montreal, Canada). Silicon and quartz substrates were purchased from Silicon Valley Microelectronics (SVM, CA, USA). (3-Aminopropyl) trimethoxysilane (APTMS, 95%) and crystal violet (CV, FW: 407.99) were purchased from Sigma-Aldrich. Hexane, ethanol (both analytical grade), hydrochloric acid (HCl, 37%), nitric acid (HNO₃, 65%), sulphuric acid (H₂SO₄, 95-97%) and hydrogen peroxide (H₂O₂) were purchased from Merck. Optical fibers with 1000 μm diameter and 0.37 numerical aperture having a hard polymer cladding with silica core was purchased from Thorlabs (BFH37-1000, fiber ID F10-056T).

### Example 2

### Characterization Methods

The zeta potential of the surface coated with micelle arrays was determined by streaming potential measurements using SurPASS electro-kinetic analyzer (Anton Par, VA, USA). Electrophoretic measurements on gold nanoparticles were carried out using Zetasizer Nano ZS (Malvern, Worcestershire, UK). The samples used for the measurement measured 20 mm×10 mm. The templates, nanoparticle clusters, and the unpatterned gold nanoparticles were characterized with tapping mode AFM (Nanoscope IV Multimode AFM, Veeco Instruments Inc., NY, USA), SEM (FESEM 6700F, JEOL, Tokyo, Japan) and TEM (Philips CM300) operating at 300 kV. The extinction spectra of the gold nanoparticles assembly on glass substrates were recorded using CRAIC Spectrophotometer (CRAIC Technologies, CA, USA). An unpolarized light source was used with measurement spot areas of 77 μm×77 μm.

### Example 3

### Preparation of Fiber Substrates

The fibers were cut into 10 cm pieces by a cleaver. The jacket and cladding were stripped to a length of approximately 1.5 cm from each end. Both ends were then polished using alumina polishing sheets (1 μm) using standard techniques. The polished ends were then washed for about 2 to 3 minutes with a jet of water and sonicated in ethanol for 10 minutes and dried.

### Example 4

### Preparation of Control Substrates (Flats Sheets and Fibers)

Silicon or glass substrates control substrates with unpatterned gold nanoparticles were prepared by first treating with UV/Ozone for 10 minutes. Subsequently, the substrates were functionalized with 3-aminopropyl trimethoxy silane in vapor phase, prior to incubation of the chip in the aqueous solution of citrate stabilized gold nanoparticles.

In case of fibers, the cladding was protected with aluminum foil exposing only the tip to the UV/ozone treatment. Silanization was performed within a desiccator at a vacuum of 5×10⁻² mTorr for a duration of 2 hours.

### Example 5

### Deposition of PS-b-P2VP Reverse Micelle Arrays on Substrate

The silicon and glass substrates were cleaned by ultrasonicating in acetone followed by 2-propanol and finally treated with UV/ozone. 0.5% (w/w) of the solution of the polymer was prepared in m-xylene.

PS-b-P2VP reverse micelle arrays were deposited from 0.5% w/w solutions of m-Xylene, using polymer with a molecular weight of 114 kDa, f_{PS}˜0.5 (f_{PS} indicates the volume fraction of the polystyrene block in the copolymer) and a polydispersity index (PDI) of 1.1. The micelles were deposited onto the substrates in the form of a thin film by spin coating at 5000 rpm, and an acceleration of 5000 rpm/s on Si or glass chips to obtain a periodicity of 88 nm. The as-coated arrays present a two-dimensionally quasi-periodic distribution of P2VP domains, covered with a thin PS film.

### Example 6

### Plasma Treatment of PS-b-P2VP Reverse Micelle Arrays on Substrate

The micellar film was subjected to a controlled exposure to oxygen plasma to tune the size of the templates. Typically, the duration of plasma exposure (30 W, 65 mT, 20 sccm) used was 22 s, 30 s and 38 s to obtain polyelectrolyte template of various sizes.

### Example 7

### Immersion of Substrate in Citrate Stabilized Gold Nanoparticle Solution

Either the as-coated templates or templates with different sizes obtained after oxygen (O₂) plasma exposure were immersed in a citrate-stabilized gold nanoparticle solution (pH 5.8) for a duration of 2 hours, and this was followed by rinsing in excess deionized water. Particle clusters were observed to form in 20 minutes, although the 2 hours duration was maintained as a standard for all samples. Longer durations did not cause a noticeable difference for the cluster characteristics. In the case of the control substrates, they were incubated in the aqueous solution of citrate-stabilized gold nanoparticles for a duration of 12 hours.

The films were subsequently incubated in an aqueous solution containing citrate-stabilized gold nanoparticles, with a diameter of 11.6 nm+/−0.79 nm at a pH of 5.8. Spatially selective clustering of nanoparticles around each micelle feature was observed.

### Example 8

### Electrostatic Attraction Between P2VP and Gold Nanoparticles

The P2VP block by the virtue of the basicity of its constituent pyridyl units exhibits a net positive charge in aqueous medium at mildly basic to acidic pH values. This is evident from isoelectric point of 8.3 measured using electrokinetic measurements performed on the as-coated PS-b-P2VP thin films, as seen in FIG. 2, where FIG. 2 is a graph showing variation in zeta potential of polystyrene-block-poly(2-vinylpyridine) (PS-b-PVP) thin film with pH of the solution. The isoelectric point (pI) of 8.3 is indicated. Also indicated is the zeta potential of 30.6 mV at a pH of 5.8, which is the pH of the citrate stabilized gold nanoparticle solution.

The ζ potential of the nanoparticles was electrophoretically determined to be −38.9 mV. The reverse micelle arrays exhibit a high positive potential ζ value of 30.6 mV at the pH of the nanoparticle suspension. Thus, the array of reverse micelles translates into an array of positively charged centers, consequently guiding negatively charged gold nanoparticles from solution to adhere strongly to the templates. This guides the spatially selective clustering of nanoparticles around each micelle feature.

Since the P2VP domains are spatially separated from each other, the clusters obtained are also spatially well isolated from each other. The number of particles in each such cluster is determined by the surface area of the reverse micelle template available for the immobilization.

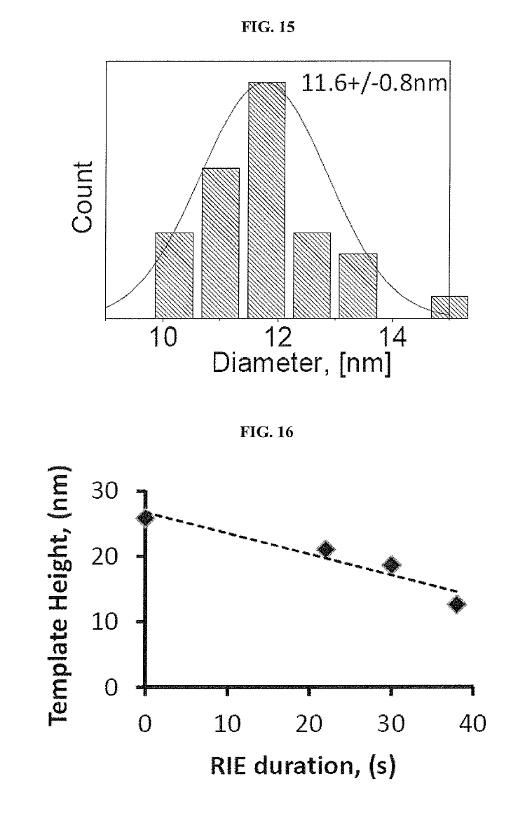

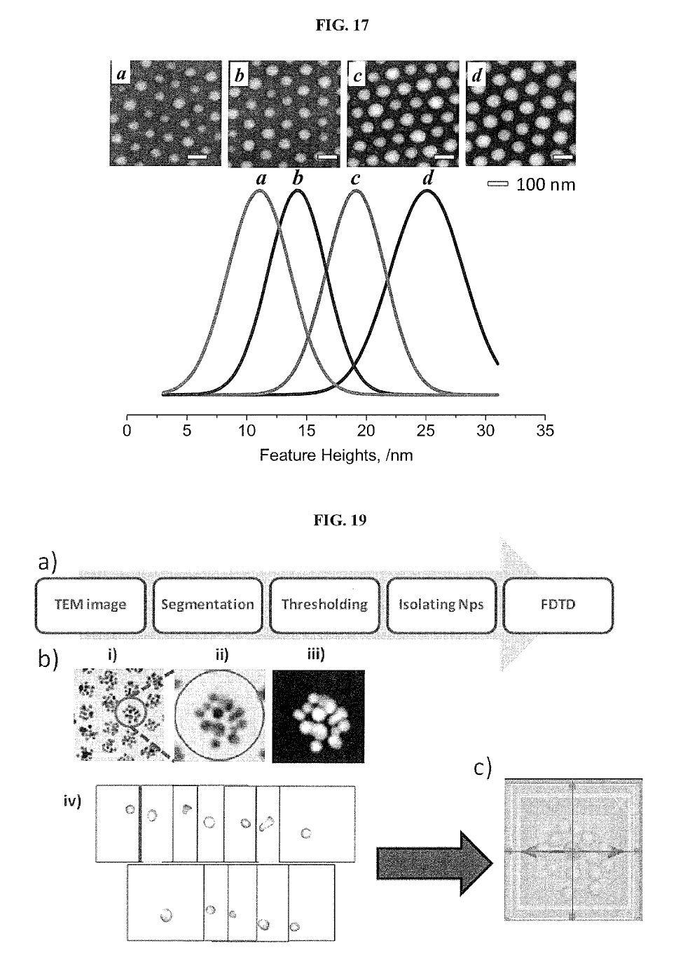

The size of the template may be varied by using smaller micelles, which in turn can be obtained either using a copolymer with smaller molecular weight, or micelle formation conditions that result in a smaller aggregation number. Alternatively, the as-obtained patterns above can be exposed to highly controlled oxygen (O₂) plasma in a reactive ion etcher, to systematically etch the polymer in steps of only a few nanometers. The latter route was used to systematically vary the template size, while keeping a constant periodicity. The oxygen (O₂) plasma conditions were optimized to have an etch rate of 19.2 nm/min. FIG. 15 is a graph showing histogram of nanoparticle diameters obtained from plan-view TEM images, showing average particle size of 11.6 (+/−0.8) nm.

### Example 9

### Characterization of Nanoparticle Cluster Array Using TEM, SEM and AFM

The nanoparticle cluster arrays were thoroughly characterized using plan-view and cross-sectional TEM, SEM and AFM measurements.

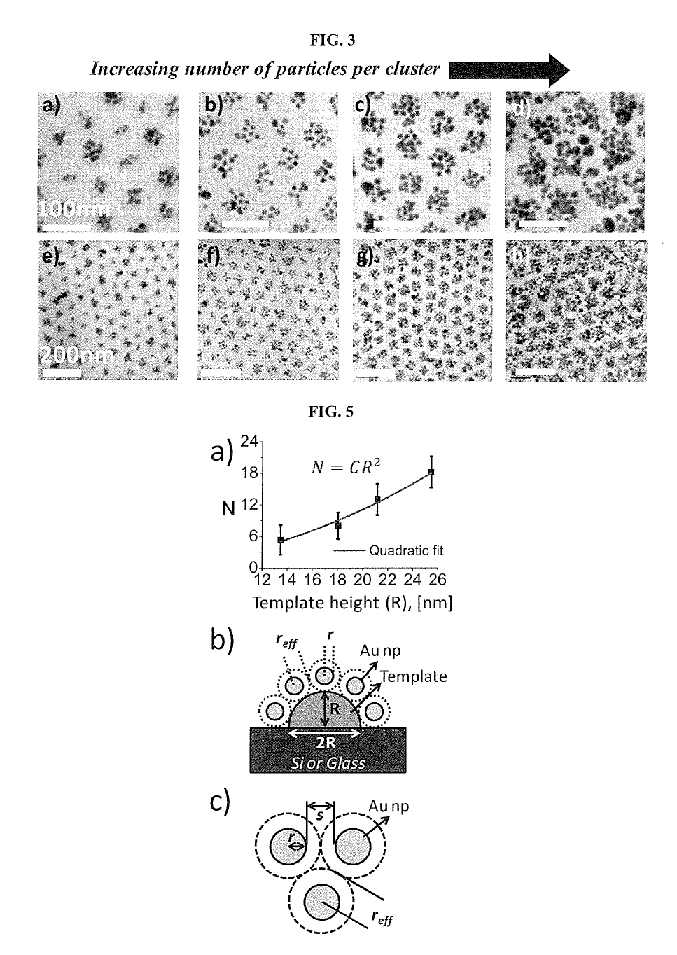

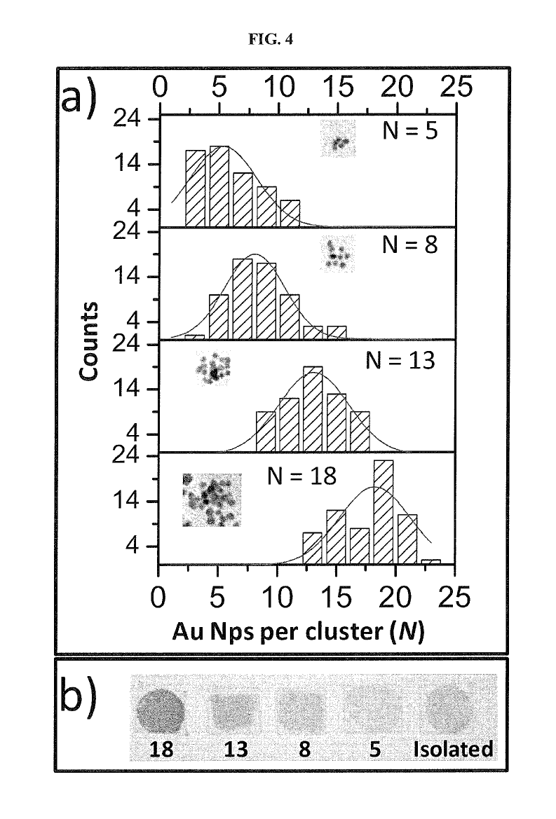

FIG. 4 provides the histogram of the number of nanoparticles per cluster (N) obtained as-coated, and using templates obtained upon 20 s, 35 s and 50 s of O₂ plasma etching. Clusters of systematically varying dimensions, viz. N=5, 8, 13 or 18 nanoparticles/cluster and low standard deviations can be seen from the plan-view TEM images and the histograms in FIGS. 3 and 4 respectively.

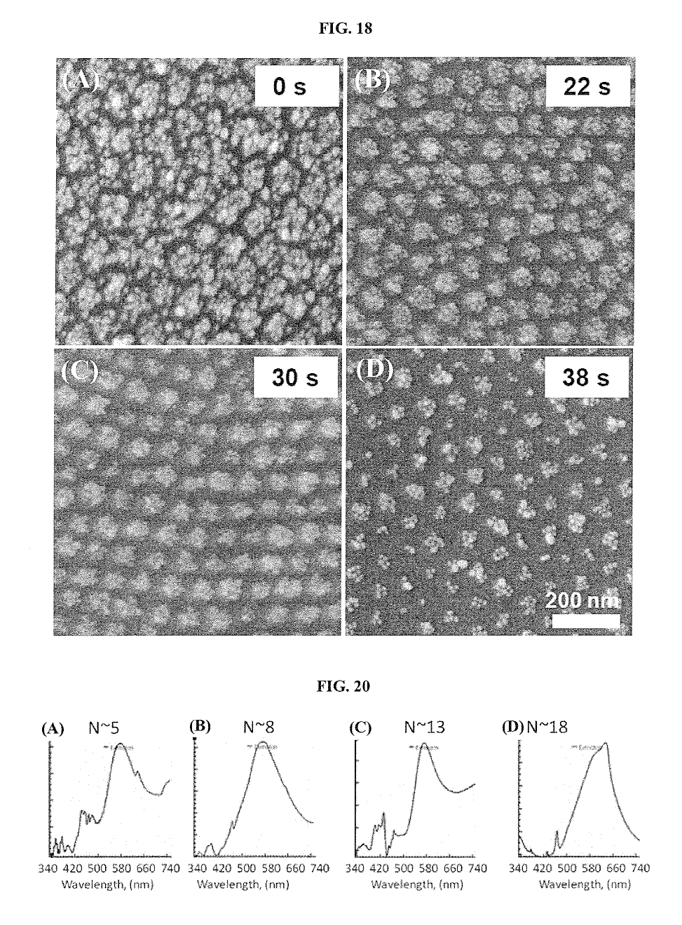

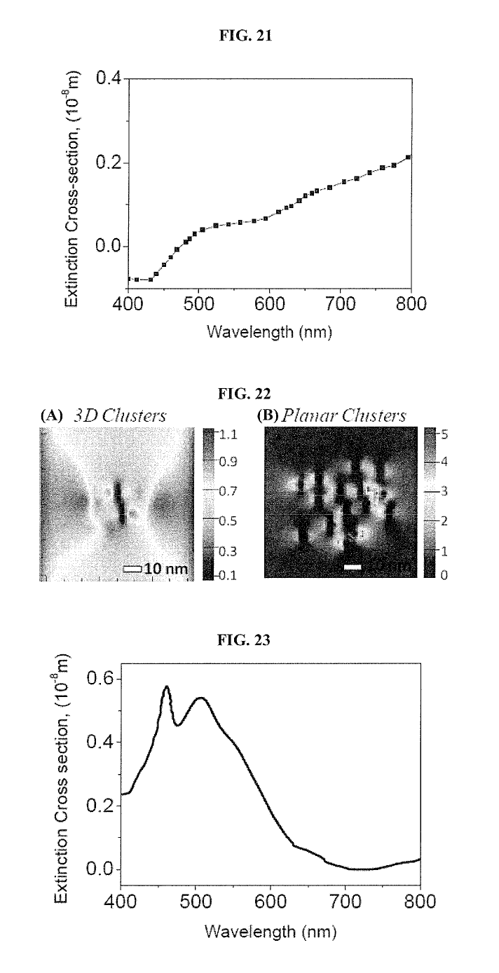

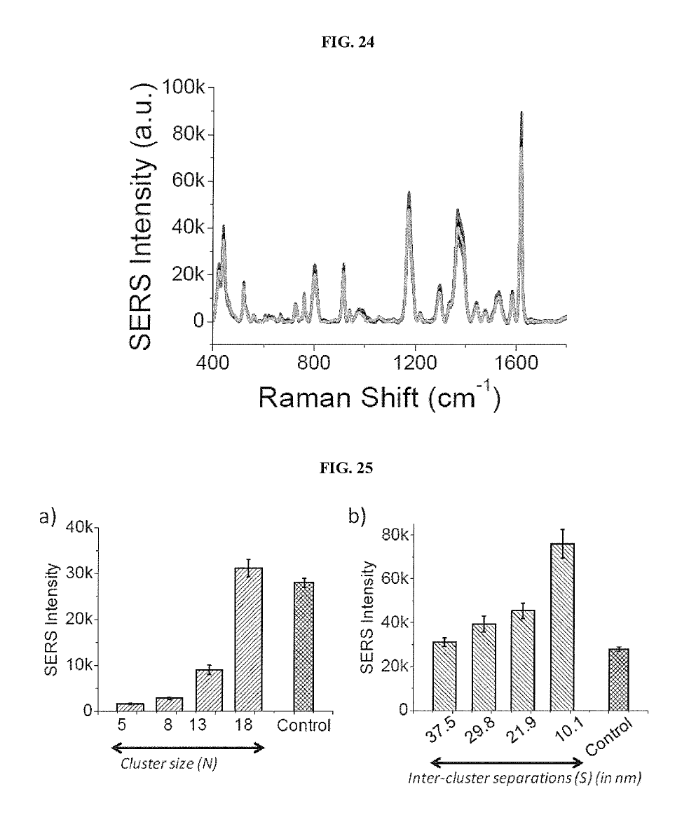

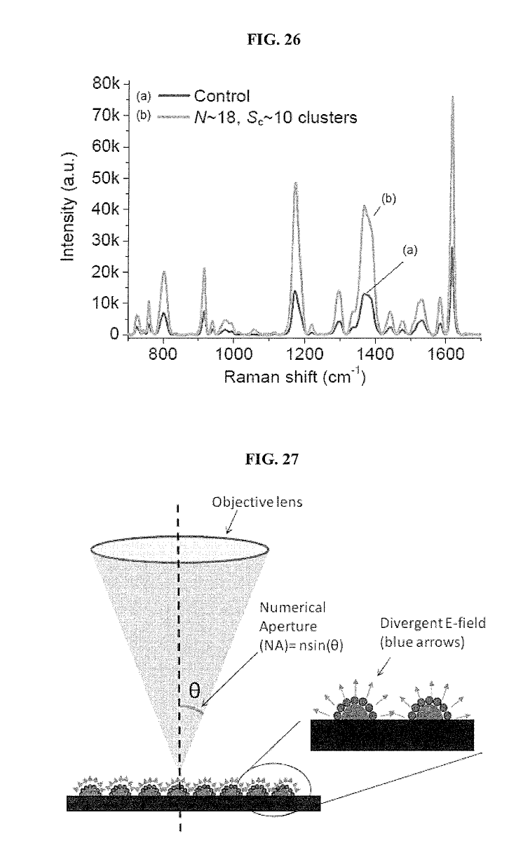

The SEM analysis (FIG. 18) was used to spot any uncovered areas and quantify the yield of the cluster formation. Based on this, the yield was determined to be close to 100%. The defects found on the chip corresponded only to the occasional presence of dust particles, or edge defects due to spin-coating process. It should be noted that the clusters are bound to a template that has a curved geometry. Therefore, the clusters are not planar and as a consequence the overlapping of the nanoparticles from different planes of focus can make them appear fused in some areas of the TEM images.

The standard deviation observed in the values for N follows directly from those of the original templates themselves. The templates exhibit a standard deviation (as percent of mean) of 11.2% for as-coated templates. As the size of the templates are reduced using O₂ plasma exposures of 22 s, 30 s, and 38 s, the standard deviation increase to 12.6%, 16.5% and 18.8% respectively. These standard deviations are well within ranges that can be reasonably expected of self-assembled systems, e.g. copolymers, colloidal spheres etc. reported in literature. Despite their inherent standard deviations, the arrays were found to exhibit remarkable uniformity across the coated area and reproducibility across different batches of preparation. This quality as shown later has very important implications for the spectroscopic utility of these arrays.

### Example 10

### Theoretical Calculation of Separation Between Adjacent Particles

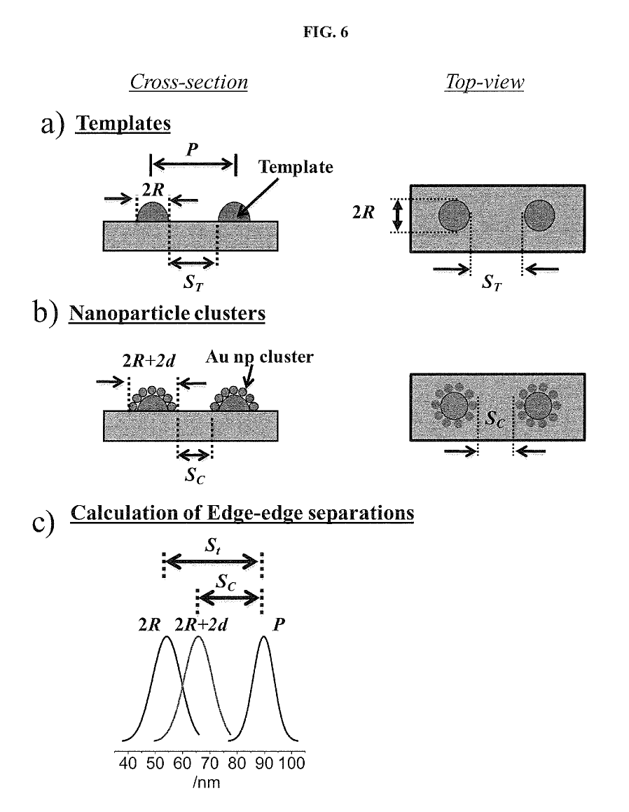

The separation between the adjacent particles is determined by the repulsive forces caused due to the negatively charged citrate ligands. The nanoparticles can therefore be considered to exhibit an effective diameter that is larger than their actual diameters that are measured using TEM. The TEM in plan-view and cross-section suggests inter-particle distances are typically less than 5 nm. However, the non-planar 3D geometry of the clusters can make the sole interpretation of the separations by TEM to be deceptive. Therefore, a simple model to estimate the inter-particle distances within the cluster was used. The model is based on estimating the effective radii of the nanoparticles through a 2D parking space available per nanoparticle on the template. The available parking space per particle is calculated by dividing the surface area of the template by the foot print of the nanoparticles. Assuming a triangular lattice, the contribution of this parking space would come from both the difference between effective and real size of the nanoparticles, as well as the area at the intersection of the features (FIG. 5). Since the area at the intersections is known through the packing efficiency (‘p’) for a 2D hcp (hexagonal close-packed) lattice, which is 90.6%, the difference between the effective and real size of the particles may be calculated:

$$\begin{matrix}{A}_{h} = 2 π {R}^{2} & ( a ) \\ {A}_{np} = π {r}_{eff}^{2} & ( b ) \\ N = \frac{p \cdot {A}_{h}}{{A}_{np}} = \frac{2 p}{{r}_{eff}^{2}} {R}^{2} = {CR}^{2} , where C = \frac{2 p}{{r}_{eff}^{2}} & ( c ) \\ {r}_{eff} = \sqrt{\frac{2 p}{C}} & ( d ) \\ s = 2 ( {r}_{eff} - r ) & ( e )\end{matrix}$$

Equation (a) provides the surface area of the templates. Equation (b) provides the foot print area available on the template for each nanoparticle. r_{eff} denotes the effective radius of the nanoparticles, which is greater than its physical radius r as shown in the schematic in FIG. 5. Equation (c) takes into account the packing efficiency in the form of parameter ‘p’ having a value of 90.6% for a hexagonal close packed (hcp) lattice. The ratio of the surface area available on a template for the particles to the foot print per particle provides N (Equation (c)).

It can be seen that N is a quadratic function of R. Therefore, by fitting a quadratic function of the form of v=Cx² to the plot of N versus R as shown in FIG. 5a, the value of the fitting coefficient C of 0.027 can be used to deduce r_{eff} using Equation (d). The inter-particle separation (s) is twice the difference between the effective and the actual radii (r) of the particles as shown in Equation (e) and in FIG. 5b. The goodness of N versus R fit was confirmed with an adjusted-R² value of 0.98. The values of r_{eff} and s were thus deduced to be 8.2 nm and 4.6 nm respectively.

Standard deviation in inter-particle separations can be expected to be influenced by the size-distribution of the templates itself, which is about 10% for arrays in their as-coated form. This value for inter-particle separation between the particles is indicative of the thickness of the electrical double layer (or, Debye length), which depends on the ionic strength of the medium.

### Example 11

### Random Sequential Adsorption (RSA) Based Simulation

Irreversible adsorption of a monolayer of charged colloids on oppositely charged surfaces have been studied extensively using random sequential adsorption (RSA) models. The maximum attainable surface coverage, also known as the ‘jamming limit’ has been predicted to be 54.7% by RSA based simulations. In this case, the surface coverage of the nanoparticles on the surface of the polymeric templates can be estimated to be about 47%. This represents a fairly high coverage, approaching the jamming limit of RSA.

In the case of unpatterned polyelectrolyte films, similar surface coverage has known to take several hours of incubation. Further, formation of nanoparticle clusters was observed to occur in duration of 30 minutes, suggesting enhanced kinetics of adsorption. The increase in kinetics is presumably caused due to confinement of adsorption within nanopatterns. This observation is interesting, considering the fact that the adsorption of colloidal particles can be considered as a model for studying the adsorption of biomolecules owing to similarity in sizes. There is evidence that a confinement of biomolecular immobilization to nanoscale areas on surface influences both the kinetics of adsorption as well as their surface density. Influence of nanopatterned areas in enhancing electrical field intensities during electrodeposition of metal thin films on surface is also of interest in this context.

The separation between templates, and consequently that of the nanoclusters, can be calculated by using experimental values for the density of micelle templates and their diameter as input.

The calculation of the separations is carried out in a similar manner to those between nanoparticles within the cluster adopted in Equations (a) to (e). The Aₜₑₘₚₗₐₜₑ represents the actual foot print area of each template and is obtained using Equation (f). A^{t}_{eff} represents the available parking area per template as given by Equation (g), where p has the same connotation as in Equation (c). R′ represents the radius of the imaginary circular area invoked in order to calculate the separation between the templates. The density (D) of micelle arrays was found to be 101 features/μm², when coated at 5000 rpm spin speed from a 0.5% w/w solution. The separation between the templates (Sₜ) is arrived at using Equations (h) and (i). The separation between the nanoparticle clusters S_{c} is then estimated by subtracting the diameter of the two nanoparticles as shown in Equation (j) and FIG. 6. The agreement of this model with experiment was tested for the TEM images for nanoparticle clusters shown in FIG. 3. The estimated separation of 37 nm agreed well with what is observed in the plan-view TEM images, confirming the validity of the model.

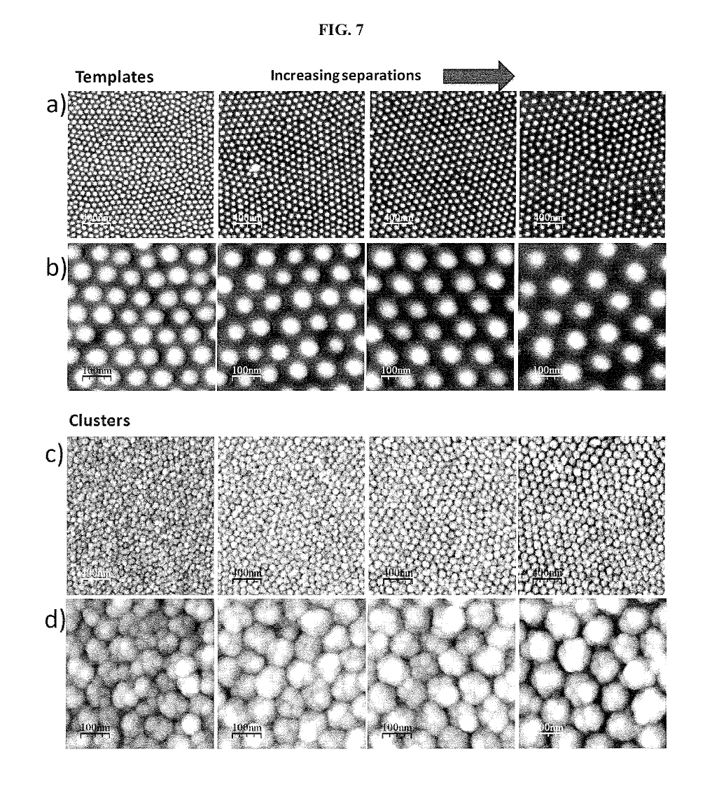

The separations between the templates could be varied systematically by coating the micelle solutions at spin-speeds varying from 1000 rpm-5000 rpm. AFM images in FIG. 7 show systematic variations in the densities (and hence, separations) of the templates as well as the nanoparticle clusters derived from them.

$$\begin{matrix}{A}_{t} = π {R}^{2} & ( f ) \\ {A}_{eff}^{t} = \frac{p}{D} = π {R}^{′ 2} & ( g ) \\ {R}^{′} = \sqrt{\frac{p}{π D}} & ( h ) \\ {S}_{t} = 2 ( {R}^{′} - R ) & ( i ) \\ {S}_{c} = {S}_{t} = 4 r & ( j )\end{matrix}$$

The separations obtained in each of these cases may be readily estimated using Equations (f) to (i), with values of 61.0, 53.3, 45.5 and 33.7 nm for the templates, and 37.6, 29.9, 22.1 and 10.3 nm for the nanoparticle clusters.

The schematic representation of the templates and the clusters in top-view and cross-sections before and after immobilization of nanoparticles is shown in FIGS. 6 (a) and (b). Calculation of edge-edge separations between the clusters is shown schematically in FIG. 6 (c), to be derived from the distribution in diameter of the templates, the clusters, and the periodicity of the array. It should be noted that the imaging of features that exhibit separations approaching sub-10 nm length scales are influenced by tip-convolution effects. This arises due to the steric hindrance felt by the tip in reaching the surface due to its typical radius of curvatures of about 5 nm to 10 nm. It can be seen as a consequence that, while the clusters at higher separations may be seen distinctly, those at the lowest separation show a much lesser distinction between the individual clusters. Also for the same reason, the AFM images of the nanoparticles within the clusters look fused, and their distinction is perceived mainly through their topography.

### Example 12

### Optical Properties of Metal Nanocluster Arrays

Aggregation of metal nanoparticles gives rise to unique optical properties due to electromagnetic multipole interactions present between the constituent particles. Aggregates of particles are known to absorb and scatter incident light more efficiently than isolated particles. Optical properties of regular multi-particle aggregates of metal colloids that behave like artificial molecules has been reported earlier. The plasmon coupling between metal nanoparticles has been reported to show considerable red-shifting of the plasmon resonance. The plasmon coupling has been shown to be a sensitive function of the inter-particle separation, and the number of nearest neighbors.

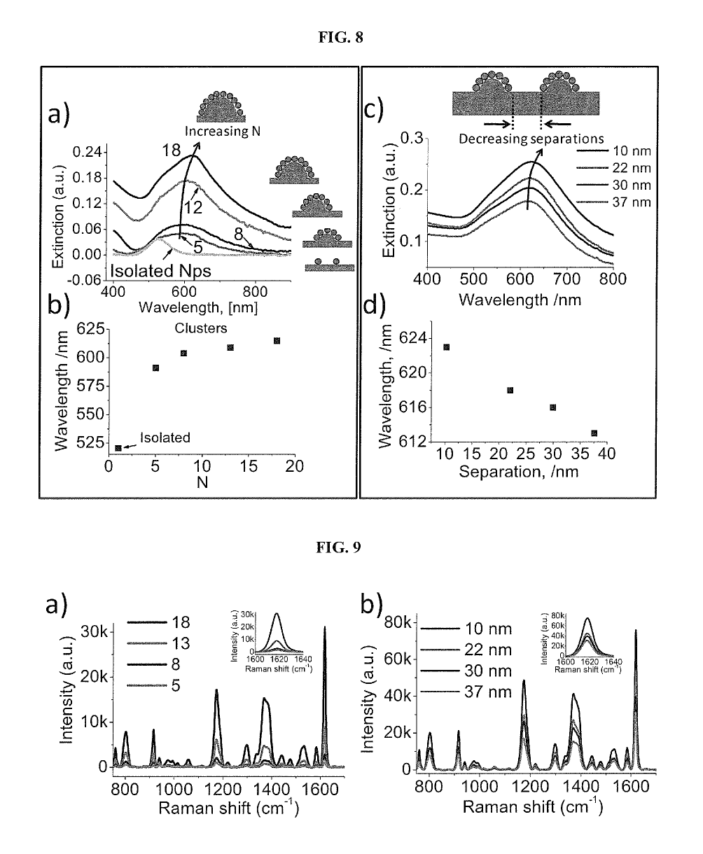

In case of clusters shown here, the inter-particle separation of 4.6 nm is lower than the particle radius of 5.8 nm, based on which an excellent coupling is expected. The strong plasmon coupling is reflected in their extinction spectra (FIG. 8) as a red-shift in resonance peak by >100 nm as compared to that of isolated nanoparticles. The extinction spectra show systematic red-shifting of resonance peak position with an increase in N (FIG. 8b). There is a weak modulation identifiable in the lower wavelength region between 520 nm to 540 nm, particularly for higher N values that can be attributed to the isolated particles. In case of random aggregates of gold nanoparticles reported earlier, the cluster dimensions as well as inter-particle separations exhibit broad distributions. This is apparent from their extinction spectra that show distinctly noticeable peak corresponding to the isolated gold particles along with a broad peak corresponding to the clusters. This is similar to those identified in gold nanoparticle heptamers particularly when the overall cluster size is small. Interesting optical properties such as Fano resonance have been shown to appear in the spectra of clusters consisting of larger particles.

Extinction spectra of nanoparticle clusters show plasmonic peak in the range of 590 nm to 620 nm corresponding to N=18, but with a systematic decrease in inter-cluster separations in the sub-50 nm regime. The extinction spectra show a systematic increase in peak wavelength until 622 nm.

The approach shown in this example can be readily extended for creating clusters with much larger particles, by choosing templates of correspondingly larger dimensions. The increase in the intensity of the extinction peaks with increase in N is in accordance with the increase nanoparticle surface concentrations.

The homogeneity of the particle clusters obtained may be perceived from the optical photograph of the samples as shown in FIG. 4b, where FIG. 4b shows samples of nanoparticle cluster arrays obtained on a glass chip. As can be seen from the photograph, there is variation in hue across the samples, which may be attributed to change in cluster size. Uniformity across the coated area of the chip is readily discernible from the photograph. This was further confirmed by a low variation in extinction intensities across the sample.

### Example 13

### SERS Performance Evaluation of Substrate

The current fabrication approach utilizes a combination block copolymer based on templating and nanoparticle self-assembly to create a two dimensional pattern of clusters. In this case, significant advantage is derived from the ultra-low separations of <5 nm between particles within the clusters, with the inter-cluster separations below 50 nm. Such interacting nanoparticles in a cluster can lead to very high SERS intensity, and the nature of fabrication may allow for excellent template uniformity resulting in low point to point variation in intensity of SERS signals. This is also a significant improvement in terms of ease and flexibility of fabrication, as the substrates with best SERS enhancements as shown do not require use of any expensive fabrication equipment, nor a clean-room environment.

In order to test the capability of cluster arrays for SERS, SERS detection using crystal violet (CV) as a model molecule have been carried out. Crystal violet has been used for the comparison of SERS results by various other groups in spite of the highly fluctuating nature observed for the SERS spectrum of the molecule. In fact, the use of a molecule that is known to exhibit high variation is more suitable to challenge the substrate performance in terms of analysis of point-to-point variations, since enhancement factors for a particular substrate in SERS is usually specific to each molecule and molecular vibrations. Also CV is an important analyte since there is an illicit use of it in the aquaculture industry as an antimicrobial in spite of its toxicity and mutagenicity to mammalian cells.

Mili-Q water from Elga Purelab Ultra distillation system, having conductivity of 18.2 MΩ-cm at 26° C., was used in all the experiments. The SERS experiments were carried out using Raman microscope (Reinshaw In Via, UK) with an excitation laser at 633 nm. The system is connected to the microscope (Lecia) and laser light was coupled through an objective lens of 50× for screening substrate, which was used to excite the sample, and the return Raman signal would be collected. A Peltier cooled CCD detector is used by the system to collect all the Raman signals. Instrument control and data acquisition were taken using the WIRE 3.0 software package provided with the Renishaw system. Calibration of instrument was done with the Raman signal from a silicon standard centered at 520 cm⁻¹.

SERS substrates were incubated overnight in 1 μM crystal violet (CV) solution to test for reproducibility and repeatability in SERS measurement. 12.24 mg of CV powder was weighed and was added to a clean scintillation vial containing 3 mL of Mili-Q water to make a concentration of 10 mM CV stock. The mixture was vortexed to ensure thorough mixing, which vas then followed by wrapping the scintillation vial with aluminum foil, as CV is light sensitive. The CV stock is stored in the refrigerator for future use. Dilution was carried out to obtain 5 mL of 1 μM CV solution.

Substrates in a “wet” condition were obtained from the scintillation vial containing the CV solution, and fixed onto the glass slide with a cover slip placed on top of the substrate, and measurements were done. Substrates in a “dried” condition were obtained from the scintillation vial of CV solution then put into a beaker of Mili-Q water and swirled for a few times to wash it. Subsequently, the substrate was dried with a stream of argon gas and fixed onto the glass slide with a cover slip placed on top of the substrate, and measurements were done.

SERS spectra were recorded at 12 random locations on the substrate using 10 s of exposure time at laser wavelength 633 nm with a power of 6.33 mW using a 20× objective lens. Spectral acquisition was accomplished using a range of about 400 to 2000 cm⁻¹ with an exposure time of 10 s and 25% transmission laser power. Subtraction of baseline was done to eliminate unwanted background noise and to facilitate data analysis.

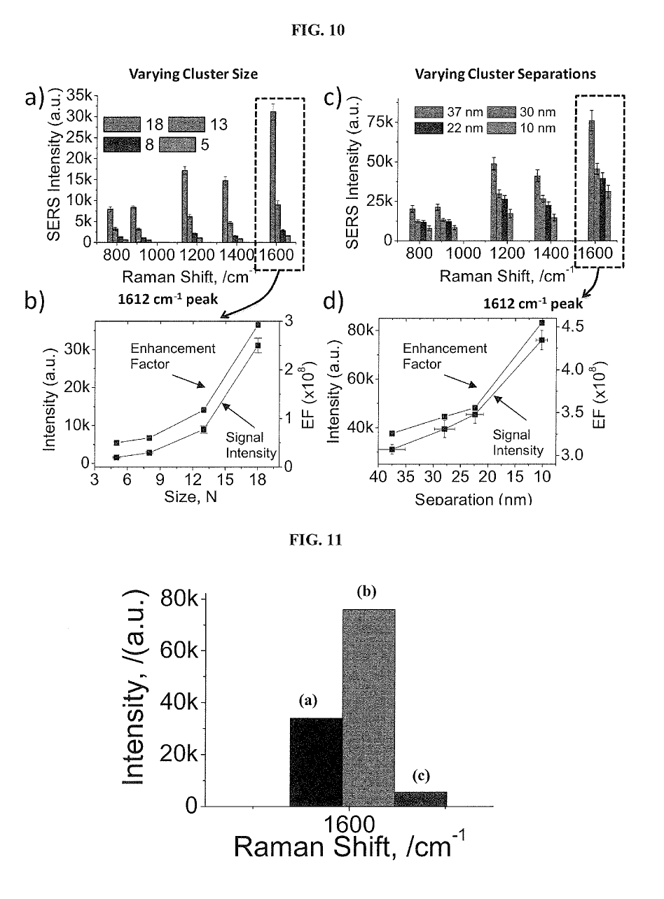

The SERS intensities for the major peaks of CV molecule are compared amongst arrays with systematically varying cluster size as well as separations. FIGS. 10 (a) and (c) are graphs showing SERS signal intensity for the major peaks of CV molecule comparing intensity enhancement with (a) increases in cluster size N, with N=5, 8, 13 and 18, and (b) decreases in cluster separation, where separation=37 nm, 30 nm, 22 nm, and 10 nm. From FIGS. 10 (a) and (c), an exponential increase in the intensity of SERS signals with increases in cluster size from N=5 to N=18 and decreases in separations from 37 nm to 10 nm may be seen. When the cluster size was varied, the separation between the clusters was maintained at a constant value of 37 nm. The highest cluster size of N=18 was maintained throughout when the separations were varied.

FIGS. 10 (b) and (d) are graphs comparing intensity and corresponding SERS enhancement factors (EF) of the most intense peak for CV as a function of (b) cluster size; and (d) separation. The extent of enhancements can be easily perceived from the plot of signal intensity of the most intense peak of CV at 1612 cm⁻¹ as a function of cluster size and separations.

From the systematic variations in cluster size and separations, a maximum enhancement was found for the arrays having N=18 clusters with separation of 10 nm. This substrate was benchmarked against un-patterned colloidal monolayers consisting of citrate stabilized gold (Au) nanoparticles adsorbed on amine-terminated self-assembled monolayers of silane on silicon (Si) substrate.

As additional comparison, the performance of the substrate obtained from various embodiments of the invention was compared against that obtained for commercial Klarite® substrates. FIG. 11 is a bar graph comparing the signal intensity for the most intense peak of CV molecule obtained on (b) cluster arrays with N=18 and separation of 10 nm, versus (a) unpatterned gold nanoparticles on silicon substrates (“unpatterned control”), and (c) commercial available Klarite® substrates as controls. The unpatterned control was obtained by adsorption of citrate stabilized gold nanoparticles on aminosilane treated silicon substrates. As can be seen from the figure, there is a clear increase in SERS performance of the clusters as compared with the controls.

Spectra recorded under the same conditions revealed that the cluster arrays performed far better in terms of signal intensity and spectral resolution. The cluster arrays were found to yield peak intensities that were higher than their unpatterned counterparts by 123%. The standard deviation in both cases could however be achieved at <10%, with the clusters exhibiting slightly lower values of 8.5% as compared to the 9.9% shown by the unpatterned colloid monolayers.

In order to quantify the actual detection limit possible in cluster configuration nanoparticles arrays on flat chips, the enhancement factor for the 1612 cm⁻¹ peak of crystal violet was calculated. The increase in SERS signal enhancement with increasing cluster size and decreasing cluster separations as shown in FIGS. 9 and 10 may be related directly to the hotspot densities. Experimental and theoretical investigations have shown that maximum enhancement depends on number of junctions between particles and such junctions are definitely higher in terms of cluster arrays due to the three dimensional nature of the array surface compared to the unaltered array. The optimized cluster array demonstrates a 23% increase in SERS intensity.

### Example 14

### Characterization of PS-b-P2VP Reverse Micelle Arrays on Optical Fiber

The cluster arrays were formed on optical fiber platform and a similar SERS analysis was carried out. In order to quantify the actual detection limit possible in cluster configuration nanoparticles arrays, the enhancement factor for the 1612 cm⁻¹ peak of crystal violet was calculated and found to be higher for cluster arrays by about 136% and about 636% over unpatterned Au nanoparticle controls, for measurements performed in remote-sensing and direct configurations, respectively.

The cluster arrays shown in the previous examples may be used to obtain high density hotspots uniformly on a fiber faucet. From a manufacturing point of view, cluster formation through simple drop-coating of PS-b-PVP reverse micelles at the tip of the optical fiber followed by self-assembly of gold nanoparticles according to some embodiments of the invention are deemed very attractive. The significance of the approach stems from the ease of achieving monolayer coverage conformally on the tip of an optical fiber faucet without having to depend on any expensive equipment, nor special clean room or environmental conditions. Further, the fiber faucet is rough in topography despite the polishing that they are subjected to. Such roughness seriously limits capability of most commonly used nanofabrication approaches in efficiently catering to creating patterns on an optical fiber tip.

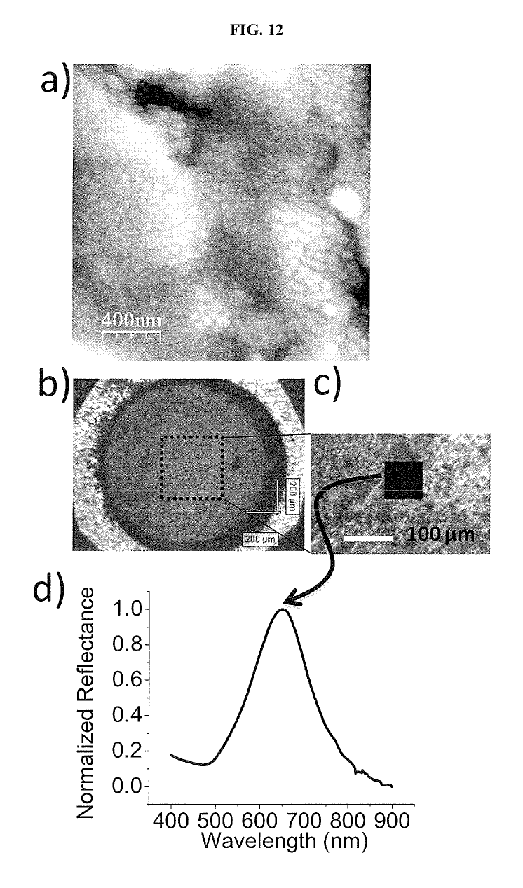

The facile coverage of the fiber tip by the reverse micelle templates in a conformal manner was confirmed through AFM imaging as seen in FIG. 12. FIG. 12 (a) is a tapping mode atomic force microscope (AFM) image of the template deposited by drop-coating on the tip of a polished optical fiber. The conformal deposition of the reverse micelles on the rough asperities of the surface of the fiber tip is clearly discernable. The scale bar in FIG. 12 (a) denotes a length of 400 nm. FIG. 12 (b) is an optical photograph of the fiber tip covered with gold nanoparticle cluster arrays. The scale bar in FIG. 12 (b) denotes a length of 200 μm. FIG. 12 (c) is an optical photograph showing the area where reflectance spectrum was collected. A microspectrometer measuring a spot of 77 μm×77 μm was used. The scale bar in FIG. 12 (c) denotes a length of 100 μm. FIG. 12 (d) is a graph showing the reflectance spectrum having a plasmonic peak at a wavelength of about 640 nm. Due to the manner in which the templates are deposited, the templates are close-packed and exhibit very low separation between adjacent features. The situation therefore is similar to the smallest separations between the template features achieved on the flat silicon chip which suggests that the resulting nanoparticle clusters would exhibit excellent SERS signal enhancements.

The fibers coated with the templates were incubated in an aqueous solution of citrate stabilized gold nanoparticles for duration of 2 h. The conditions used were maintained the same as for the preparation of nanoparticle cluster arrays on flat chips. The resulting nanoparticle arrays were characterized using microspectrometry that allowed acquiring reflectance measurement on areas measuring only few tens of microns across. The reflectance spectrum was acquired in spot areas measuring 77 μm×77 μm that reveal a prominent peak at about 640 nm due to scattering due to localized surface plasmons of the nanoparticle cluster arrays as can be seen in FIG. 12 (a) to (d).

The uniformity of the nanoparticle cluster arrays could be confirmed by the excellent uniformity in peak-wavelength positions for spectra recorded at different areas of the fiber faucet. The observed peak wavelength of 640 nm in the case of nanoparticle clusters formed on the fiber-tip suggests inter-cluster separations that are even lower than the smallest separations observed on the flat-chips. This enhanced separation between the features on the fiber tip as compared to the flat chip can be attributed to the nature of template deposition, where spin-coating is carried out on flat chips, and drop-coating is carried out on the optical fiber faucet.

The drop-coating tends to create close-packed assemblies of reverse micelles, as supported by the evidence from the atomic force microscope (AFM) of the templates as shown in FIG. 12. The imaging of the nanoparticle cluster arrays formed on the fiber faucet by scanning electron microscopy (SEM) was complicated by the heavy charging of the non-conducting glass substrate. The AFM measurements, on the other hand, are significantly limited due to tip-convolution effects for ultra-low separations as encountered in this case.

In view of the above, to demonstrate nanoparticle cluster formation on the fiber, the images obtained from AFM measurements and results from the microspectrometry measurement performed on the nanoparticle clusters obtained after self-assembly of gold nanoparticles are used as evidence for the formation of templates.

### Example 15

### SERS Performance of Optical Fiber

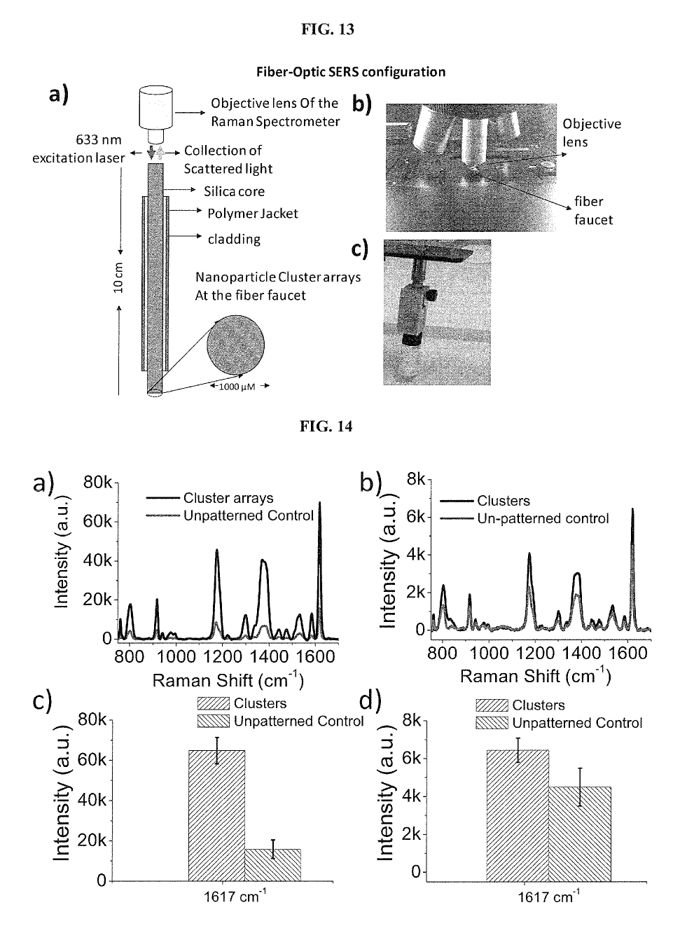

The SERS performance of the optical fiber was tested by using CV as the model analyte as for the flat chips. The configuration used for measuring the SERS response by the fiber-faucet dipped into the CV solution is illustrated in FIGS. 13(b) and (c). The fiber end of the clusters is dipped into a vial containing the CV solution, while the SERS spectrum of the CV molecule is measured through the other end of the fiber which faces the objective lens of the Raman spectrometer. For testing purposes, the Raman spectrum was also measured in backscattering geometry, under conditions same as that employed on flat-chips.

A comparison of the remotely performed measurement with direct measurement in backscattering geometry is shown in FIG. 14. FIG. 14 are graphs comparing the SERS signal intensity measured under (a) direct configuration; and (b) indirect configuration for nanoparticle cluster arrays versus unpatterned controls. The unpatterned control includes isolated nanoparticles obtained by electrostatic adsorption of gold nanoparticles to aminosilane treated fiber. The direct measurement configuration measures SERS under backscattering geometry on the fiber tip surface incubated in CV solution overnight. The indirect configuration corresponds to SERS measurement performed through the fiber, with the cluster containing end dipped in solution and the other end facing the objective. FIGS. 14 (c) and (d) are graphs comparing between the most intense peak of CV spectra shown in FIGS. 14 (a) and (b) respectively.

In both cases, the SERS performance of the fiber faucet covered with cluster arrays is compared against control fibers of faucet covered with randomly adsorbed gold nanoparticles. The control fibers were prepared in the same way as flat-chip controls, by exposing glass fiber tips covered with amine terminated silane SAMs to an aqueous solution of citrate-stabilized gold nanoparticles for duration of 12 h. The direct SERS measurements performed in the backscattering geometry show that the signal intensities obtained on the fiber faucet are comparable with that observed in the case of cluster-arrays with lowest separations on flat-chips. The unpatterned chips, however, showed a rather lower response as compared to the flat chips. The remote sensing measurements clearly reveal both higher signal intensity as well as lower signal intensity variations for the fiber faucet with clusters as compared to the control fibers.

In order to quantify the actual detection limit possible in cluster fiber configuration nanoparticles arrays, the enhancement factor for the 1612 cm⁻¹ peak of crystal violet was calculated, and found to be 136% and 636% higher for cluster arrays as compared to the unpatterned nanoparticle controls for signal intensities detected on the indirect or direct ends of the fiber respectively.

The copolymer assembly is used to produce two-dimensionally patterned array of polyelectrolyte centers with sub-100 nm feature widths, which are then used to create arrays of gold nanoparticle clusters through simple electrostatic attachment. The spatial distribution of the polyelectrolyte containing centers can be controlled in steps of few nanometers to yield separations down to sub-10 nm length scales. Using this approach, gold nanoparticle clusters with 1<n<20 with 5 nm<δ<40 nm on Si and glass substrates over areas of a 1 cm×1 cm chip have been demonstrated.

### Example 16

### Comparative Studies Using E-Beam Lithography

A multi-scale signal enhancement arising out of collective optical behavior due to the plasmonic coupling between nanoparticles both within and between the clusters has been investigated. Arrays using e-beam lithography (EBL) over areas of 25.4 μm×25.4 μm, with average number of nanoparticles in the clusters (n) and edge-to-edge separation (δ) in the range of 1<n<20 and 50<δ<1000 nm have been fabricated. Significantly low inter-cluster separations, and cluster arrays spanning areas larger than a few tens of microns are not practical using EBL, due to limitations associated with the use of EBL. Further, EBL does not efficiently cater to 3D substrates, e.g. glass capillary, or glass fibers. Further, earlier reports in literature that use gold colloids to achieve SERS capability often do not quote the inter-particle separations, despite significant importance of this value toward SERS enhancements. In addition, when polymeric coatings are used to passivate the surface of the nanoparticles, it is difficult to achieve ultra-low separations due to the finite thickness of the passivation layer.

### Example 17

### Effects of Humidity on Template Formation

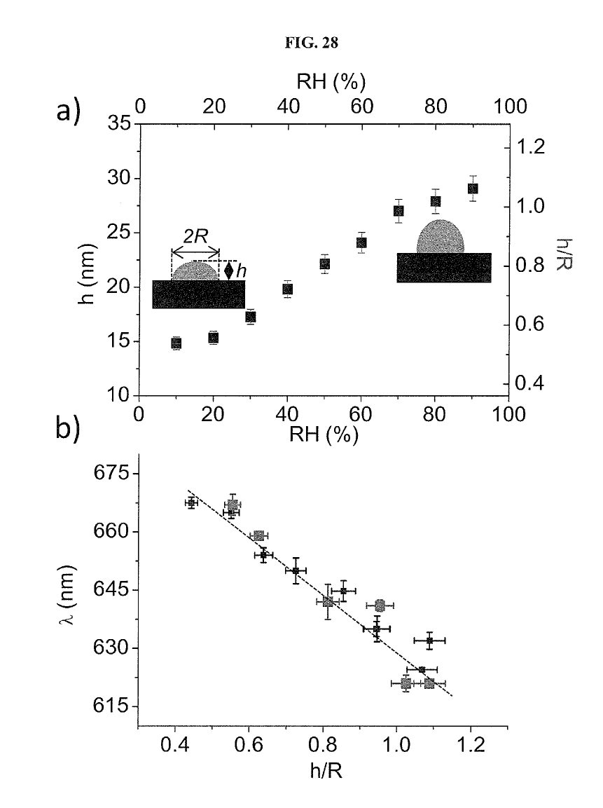

FIG. 28 are graphs showing (a) systematic variation in curvature (or height (h) to radius (R) ratio) of the reverse micelle templates on surface, as a function of relative humidity of the environment during thin film formation; (b) systematic variation in the plasmon resonance of nanoparticle cluster arrays with variations in the h/R ratio. The fine-tunability in curvature is a possibility that arises with a composite core-shell system such as the reverse micelles. The change arises due to the possible increase in surface tension at the interface of polystyrene and polyvinyl pyridine, due to absorption of moisture within PVP, to the extent there is moisture content in the surrounding, during the formation of templates on surface. Such fine-tunability in curvature is found to yield tunability in plasmon resonance. It is a significant capability of interest to achieve higher SERS performance of the resulting arrays. There is a possibility of fine-tuning the plasmon resonance close to the molecular absorbance, and the laser excitation wavelength used in order to realize high SERS enhancements.

The relative humidity of the environment was controlled between about 10% to 90%, in a custom-designed environmentally controlled glove box equipped with a spin-coater inside. It is important to ensure the relative humidity of the environment at the time of the spin-coating step, as the influence due to humidity is felt during the template formation step on surface. The height of the template features for coatings prepared under different humidity values were characterized using atomic force microscopy. The templates with different values of curvature were subjected to incubation in Au nanoparticle solution for a duration of 3 hours. The optical absorbance of resulting cluster arrays on glass substrate were measured using a microspectrometer (CRAIC Technologies). The curvature is presented as a ratio of the height to the radius of the feature as shown in FIG. 28. The errors due to tip convolution effects in AFM toward measurement of the radius were taken into account as indicated by the error bars.

### Example 18

### Experimental Conditions in Preparation of Super-Clusters

Polystyrene-block-poly(2-vinylpyridine) with a molecular weight of 380 kDa, with f_{PS}˜0.5 was coated on silicon or glass surface at 6000 rpm. The template feature exhibited a periodicity (or pitch) of about 200 nm. The template coated substrate was immersed in 5 mM solution of chloroauric acid (HAuCl₄) for a duration of 1 hour, and then subjected to O₂ plasma RIE for a duration of 10 minutes (at 65 mTorr, 30 W, 20 sccm of O₂ flow).

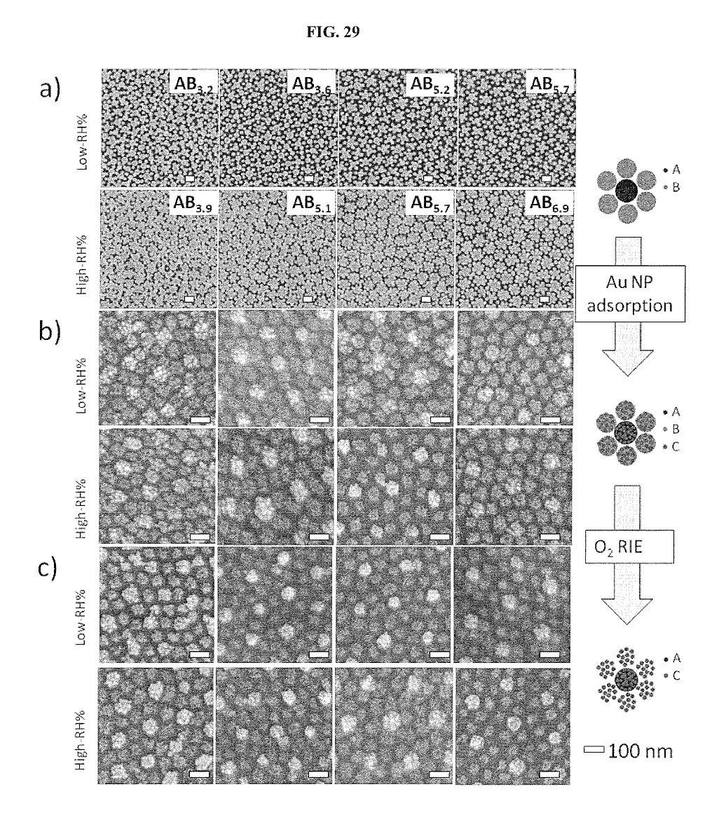

The gold salt (HAuCl₄) concentrates within the PVP blocks of the template, and the subsequent removal of the polymer therefore facilitates in the reduction of gold salt and in situ formation of Au nanoparticles (indicated as ‘A’ in FIG. 29).

These in situ formed Au particles are subsequently used as templates for coating reverse micelle templates formed out of PS-b-P2VP 114 kDa and f_{PS}˜0.5. The reverse micelles (indicated as ‘B’ in FIG. 29) organized around the in situ formed Au NP features. The average number of reverse micelles per Au nanoparticle (NP) template (indicated as x) was calculated through histograms, and is as indicated within FIG. 29a. These arrays of super-clusters (ABx) with reverse micelles surrounding Au NPs were subjected to incubation in a solution of citrate-stabilized Au nanoparticles as in the earlier examples. The citrate-stabilized Au nanoparticles (indicated as ‘C’ in FIG. 29a) adsorb around each reverse micelle feature, and in addition also were found to adsorb around the central Au nanoparticle template. This results in super-clusters of nanoparticle cluster arrays (FIG. 29b).

The adsorption of the ‘C’ to ‘B’ is through electrostatic attraction (as in the primary examples of nanoparticle cluster formation. The adsorption of the ‘C’ to ‘A’ however is expected to be mediated through PS-b-PVP molecules of sub-CMC concentrations that adsorbed on to ‘A’, providing it with a positive charge. This aspect is especially interesting, as it allows the cluster formation to be achieved also through charged polyelectrolyte functionalization of passive un-charged nanoparticle surfaces. The composition of the super-clusters of nanoparticle cluster arrays could be systematically controlled by varying separation between ‘A’ features, and by controlling the relative humidity during coating of ‘B’.

### Example 19

### Removal of the Polymer Template

The substrate of the Au nanoparticle cluster arrays was subjected to O₂ plasma reactive ion etching (Oxford plasmlab100, Oxford Instruments, UK) for a duration of 10 minutes (at 65 mTorr, 30 W, 20 sccm of O₂ flow), to completely remove all the polymeric support. The characterization of the nanoparticle clusters were performed using atomic force microscopy and scanning electron microscopy. The arrangement of the nanoparticle clusters was found to be unaffected. The separation between individual nanoparticles within the cluster is however not readily known from this characterization. The SERS analysis of the particle clusters following the RIE shows significant enhancement over the clusters with the polymeric support intact. This was found to be the case with both the nanoparticle clusters, and the nanoparticle super-clusters. This provides an indirect proof that there the hotspots at the inter-particle junctions within the clusters are preserved, and that the inter-particle separations could have decreased as a result of the polymer removal (from geometric considerations).

### Example 20

### SERS Enhancement Results

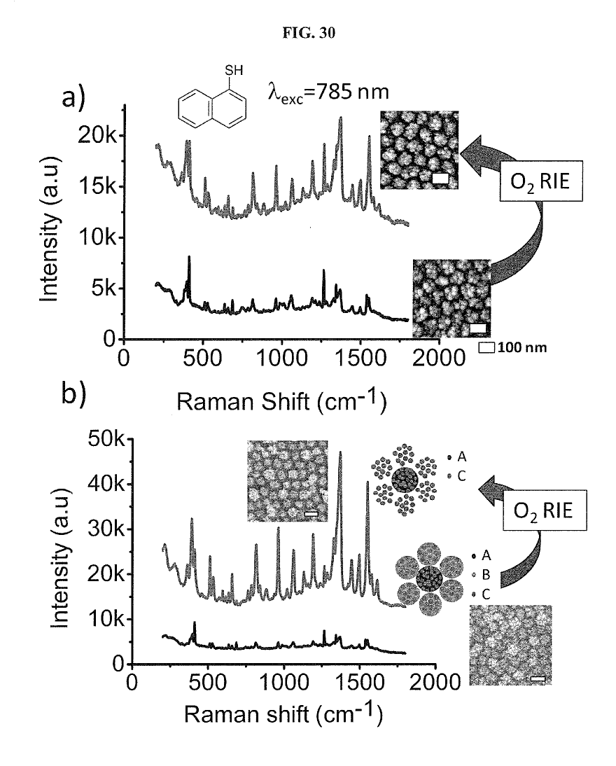

FIG. 30 are graphs showing removal of supporting polymer template result in higher SERS enhancements due to a closer separation between nanoparticles, contrary to earlier beliefs that the nanoparticle formed a fused mass by coalescing together. All spectra were recorded under identical conditions of probe molecule deposition, laser excitation wavelength, exposure duration and laser power. The SERS enhancement was found to distinctly increase upon removal of the polymer template as shown in FIG. 30 (a). The enhancement further increased upon formation of a super-cluster (with polymer removed), as shown in FIG. 30 (b). The influence on the SERS enhancement due to super-cluster formation may have contributions from the central gold nanoparticle template, along with the complex plasmonic coupling due to the super-cluster geometry.

### Example 21

### Advantages

A template-driven approach based on copolymers consisting of a polyelectrolyte block has been developed. In various embodiments, a block copolymer such as the PS-b-P2VP is used in the form of micelle arrays deposited on surface to form templates.

The ability to tune the size and separation of the micelle templates may be easily and readily translated to control the size and separation between nanoparticle clusters. As demonstrated herein, the approach produces particles with sub-5 nm separations, over macroscopic 2D/3D areas, with excellent SERS performance in terms of both signal intensities as well as reproducibility.

In addition, since the patterns on surface are formed by deposition of pre-formed templates from solution-phase, the approach readily caters to fragile or 3D surfaces or substrates that cannot withstand annealing at high temperatures. Accordingly, the use of surface-attached templates using self-assembly approaches, e.g. copolymer lithography using phase-separated thin films, nanosphere lithography (NSL) or anodic aluminum oxide (AAO) would therefore be limited in their capability towards catering to such surfaces.

The clusters, due to their very low inter-particle separations, high densities and uniformity, provide excellent opportunity for use as SERS substrates due to high density of hotspots. In various embodiments, the inter-particle separations of the metallic nanoparticles may be made even smaller by formation of ‘super-clusters’ as described above. The control of inter-particle and inter-cluster distances can lead to efficient tuning of the SERS properties. Results from the experiments carried out have shown that the SERS performance of the substrate increases with increases in cluster size and decreases in inter-cluster separations. The optimized substrates show excellent SERS performance, with very low signal variations of ≦10% within and across samples. The low standard deviations of the polymeric templates employed in the experiments allow excellent consistency and reproducibility of the SERS signals. In addition, the best performing SERS substrates shown herein can be readily realized without the use of expensive equipment of any kind, on 2D or 3D substrates, and within short times, over arbitrarily large areas.

Another important advantage of some embodiments would be the facile adaptability of fabrication to remote sensing constructs such as optical fiber probes. This allows easy sampling and avoids the hazards associated with free space laser beams. Since normal Raman scattering spectroscopy has been highly successful in remote sensing and biomedical applications, a lot of effort has been directed at the development of SERS active optical fibers. It is postulated that formation of a cluster array on fiber would effectively address the problem of complete blockage of hollow fibers with nanoparticles that is encountered in many nanoparticle-based fabrication approaches. Due to the blockage, the wavelength response of such cluttered fiber probes is very unpredictable and hence not practical in SERS biosensing. The absence of such cluttering in the template directed cluster formation in these examples allow predictable wavelength response and increased collection efficiency in back scattering geometry, when excitation and collection of signal is achieved through the fiber using the rear end of the fiber. This type of bidirectional probes where one side of the fiber features well controlled cluster arrays and other side used for the input and collection of the SERS signals would have tremendous practical implication in remote sampling conditions for SERS based sensing.

In summary, a simple, yet highly promising means of producing macroscopic arrays of nanoparticle clusters with engineered SERS response on both flat and 3D substrates is presented. Nanoparticle clusters may be efficiently obtained using electrostatic attachment to charged nanoscale polyelectrolyte template formed out of polystyrene-block-poly(2-vinylpyridine) copolymer reverse micelles. Changes in optical properties and the resulting SERS response were observed by varying the number of nanoparticles per cluster from N=5 to N=18, and separations of N=18 clusters from 37 nm to 10 nm. The best signal enhancements were observed for the largest clusters with the smallest inter-cluster separations. The convenient handles to tune the size and separation between reverse micelle templates, allow facile variation in the geometric characteristics of the nanoparticle clusters. The uniformity and the reproducibility of the templates allowed realizing clusters that offered both uniform optical properties and reproducibly low SERS signal intensity variations. Further, such techniques could be readily translated into a fiber faucet allowing for remote sensing of analyte by SERS. The characteristics of the templates obtained on the optical fiber faucet closely resemble those on the flat chip for their uniformity and observed SERS signal intensities. The SERS performance of the clusters on flat chips as well as optical fibers was benchmarked against performance of unpatterned gold nanoparticle monolayers. The cluster arrays clearly show both higher signal intensity as well as low signal variations as compared with the controls. The optimization and further studies on the fabrication side as well as the studies relating to the fiber configuration and other optical parameters can bring out the SERS performance to level to cater the ever-increasing need of remote monitoring of various analyte in biological and chemical sciences.

1. A method of manufacturing a metal nanoarray substrate, the method comprising
a) providing a support;
b) forming a template by attaching a plurality of polymeric nanoparticles each having a core-shell structure to the support, wherein the core comprises a first polymer and the shell comprises a second polymer; and
c) forming the metal nanoarray substrate by attaching a plurality of metallic nanoparticles to the polymeric nanoparticles of the template.

2. The method according to claim 1, wherein the plurality of polymeric nanoparticles is formed by
a) copolymerizing the first polymer and the second polymer to form an amphiphilic copolymer; and
b) dispersing the amphiphilic copolymer in a suitable solvent to form reverse micelles.

3. The method according to claim 1, wherein the template size and geometry is controlled by controlling the size and geometry of the polymeric nanoparticles by controlling the molecular weight of the polymer or the polymeric nanoparticle-forming conditions.

4. The method according to claim 3, wherein control of the polymeric nanoparticle-forming conditions comprises control of the relative humidity during polymeric nanoparticle formation.

5. The method according to claim 4, wherein the polymeric nanoparticles are reverse micelles.

6. The method according to claim 1, wherein the first polymer exhibits a positive charge in an aqueous medium having a pH of less than about 8.

7. The method according to claim 1, wherein the first polymer comprises a unit selected from the group consisting of vinyl pyridine, N-(3-aminopropyl)methacrylamide (APMA), N-(3-dimethylaminopropyl)methacrylamide, methacrylamidopropyl trimethylammonium chloride, aminostyrene, ornithine, lysine, amidines, guanidines, hydrazines, phosphonium salts, and mixtures thereof.

8. The method according to claim 1, wherein the first polymer comprises poly(2-vinyl pyridine).

9. The method according to claim 1, wherein the second polymer comprises a hydrophobic unit.

10. The method according to claim 1, wherein the second polymer is selected from the group consisting of polystyrene, polyolefin, polysiloxane, polyvinyl naphthalene, polyvinyl anthracene, and mixtures thereof.

11. The method according to claim 10, wherein the second polymer comprises polystyrene.

12. The method according to claim 1, wherein the polymeric nanoparticles comprises or consists essentially of a block copolymer of polystyrene and poly(2-vinylpyridine).

13. The method according to claim 1, wherein the plurality of polymeric nanoparticles forms an array having an average inter-particle distance of less than 50 nm on the support.

14. The method according to claim 13, wherein the plurality of polymeric nanoparticles forms an array having an average inter-particle distance of about 10 nm on the support.

15. The method according to claim 1, wherein the polymeric nanoparticles attached to the surface are subjected to a treatment to vary the template size or remove the polymeric template.

16. The method according to claim 15, wherein the treatment comprises reactive ion etching.

17. The method according to claim 1, wherein the metallic nanoparticles are negatively charged metallic nanoparticles.

18. The method according to claim 1, wherein the metallic nanoparticles are attached to the polymeric nanoparticles by electrostatic interaction.

19. The method according to claim 1, wherein the metallic nanoparticles comprise or consist essentially of gold.

20. The method according to claim 19, wherein the metallic nanoparticles are citrate-stabilized gold nanoparticles.

21. The method according to claim 1, wherein the metallic nanoparticles attached to the exposed cores of the polymeric nanoparticles have an inter-particle distance of less than 5 nm.

22. The method according to claim 1, wherein the mean diameter of the metallic nanoparticles is in the range of about 5 nm to about 15 nm.

23. The method according to claim 1, wherein the polymeric nanoparticles and/or the metallic nanoparticles are essentially monodisperse.

24. The method according to claim 1, wherein the average number of metallic nanoparticles on each polymeric nanoparticle is in the range of about 1 to about 25.

25. The method according to claim 24, wherein the average number of metallic nanoparticles on each polymeric nanoparticle is about 18.

26. The method according to claim 1, wherein the support comprises a metallic nanoparticle attached to the surface of the support, wherein the metallic nanoparticle is formed by first forming a polymeric nanoparticle, contacting the polymeric nanoparticle with a solution containing metal ions, and removing the polymer, thereby forming metallic nanoparticles in situ.

27. The method according to claim 26, wherein the metallic nanoparticle is a gold nanoparticle.

28. The method according to claim 26, wherein the polymeric nanoparticle comprises or consists essentially of a block copolymer of polystyrene and poly(2-vinylpyridine).

29. The method according to claim 26, wherein the solution containing metal ions is an aqueous solution containing gold ions.

30. The method according to claim 26, wherein the polymer is removed by reactive ion etching.

31. The method according to claim 26, wherein the formation of the template is carried out by attaching a plurality of polymeric nanoparticles each having a core-shell structure to the metallic nanoparticles attached to the surface of the support.

32. The method according to claim 31, wherein forming the metal nanoarray comprises attaching a plurality of metallic nanoparticles to the polymeric nanoparticles of the template and the metallic nanoparticles attached to the surface of the support.

33. The method according to claim 1, wherein the formation of the template is carried out by attaching a plurality of polymeric nanoparticles each having a core-shell structure directly to the surface of the support.

34. The method according to claim 1, wherein the surface of the support where the plurality of polymeric nanoparticles is attached to is non-planar.

35. The method according to claim 1, wherein the support comprises an optical fiber.

36. The method according to claim 35, wherein the plurality of polymeric nanoparticles is attached to the optical fiber by drop coating.

37. The method according to claim 1, wherein the first polymer exhibits an electric charge when present in an aqueous solution.

38. A metal nanoarray substrate obtained by the method of claim 1.

39. A metal nanoarray substrate obtained by the method of claim 32.

40. A biosensor comprising a metal nanoarray substrate manufactured by a method according to claim 1.

41. A method for the detection of an analyte in a sample by SERS, comprising contacting the sample with the biosensor according to claim 40.
